(19) United States
(12) Patent Application Publication
(10) Pub. No.: US 2026/0353168 A1
(43) Pub. Date: Nov. 5, 2026

(54) METHOD AND DEVICE FOR DISTINGUISHING SIDELINK RELAY TRANSMISSION DATA USAGE

(71) Applicant: Samsung Electronics Co., Ltd., Gyeonggi-do (KR)

(72) Inventors: Beomsik BAE, Gyeonggi-do (KR); Hyunjeong KANG, Gyeonggi-do (KR)

(21) Appl. No.: 18/997,350

(22) PCT Filed: Jun. 29, 2023
(86) PCT No.: PCT/KR2023/009157

§ 371 Date: Jan. 21, 2025

(30) Foreign Application Priority Data
Jul. 28, 2022 (KR) 10-2022-0094189

(51) Int. Cl. H04W 28/02; H04M 15/00; H04W 76/30; H04W 92/18

(52) U.S. Cl. CPC H04W 28/0268; H04M 15/58; H04W 76/30; H04W 92/18

(57) ABSTRACT

The present invention relates to a method comprising the steps of: transmitting a first message including information indicating whether a remote user equipment (UE) is in a state of being connected through a sidelink relay to a central unit-user plane (CU-UP) of a base station; when a preconfigured condition is satisfied, receiving, from the CU-UP, a second message including information on data usage using the sidelink relay of the remote UE; and transmitting a third message including the information on the data usage using the sidelink relay of the remote UE to an access and mobility management function (AMF).

### TECHNICAL FIELD

The disclosure relates to operations of a base station, a user equipment, and a core network in a mobile communication system.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

An embodiment of the disclosure provides a method in which in a mobile communication system, when a UE receives a mobile communication network service by performing communication connection with a mobile communication network by using a sidelink relay technology through a connection with a relay support UE, a usage time and usage of data services through the sidelink relay can be distinguished, and the distinguished data usage information through the sidelink relay is to be utilized for charging information, etc.

In addition, an embodiment of the disclosure is to provide a method in which a base station transfers, to a core network, a case where a UE is directly connected to a mobile communication base station and whether the UE is connected to the mobile communication base station through a sidelink relay, so as to change a connection policy, e.g., a QoS parameter configuration.

The technical subjects pursued in the disclosure may not be limited to the above-mentioned technical subjects, and other technical subjects which are not mentioned may be clearly understood, through the following descriptions, by those skilled in the art to which the disclosure pertains.

### Solution to Problem

To solve the above-described problem, a method performed by a central unit-control plane (CU-CP) of a base station in a wireless communication system according to an embodiment of the disclosure may include transmitting, to a central unit-user plane (CU-UP) of the base station, a first message including information indicating whether a remote user equipment (UE) is in a state of being connected through a sidelink relay, in case that a preconfigured condition is satisfied, receiving, from the CU-UP, a second message including information on data usage by means of the sidelink relay of the remote UE, and transmitting, to an access and mobility management function (AMF), a third message including information on the data usage by means of the sidelink relay of the remote UE.

In addition, the method may further include in case that a connection state of the remote UE is changed from a connection through the sidelink relay to a radio interface connection with the base station, transmitting, to the CU-UP, a fourth message including information indicating a state in which the connection through the sidelink relay is released, receiving, from the CU-UP, a fifth message including information on data usage by means of the sidelink relay of the remote UE until the connection through the sidelink relay is released, and transmitting, to the AMF, a sixth message including information on the data usage by means of the sidelink relay of the remote UE.

In addition, the first message may include at least one of a bearer context setup request message or a bearer context modification request message In addition, the information on the data usage by means of the sidelink relay of the remote UE may be a value calculated for each protocol data unit (PDU) session or each quality of service (QOS) flow.

In addition, the information on the data usage by means of the sidelink relay of the remote UE may include at least one of information associated with a start time point of performing data transmission or reception using the sidelink relay, information associated with an end time point of performing data transmission or reception using the sidelink relay, uplink data usage information, or downlink data usage information.

In addition, to solve the above-described problem, a method performed by a central unit-user plane (CU-UP) of a base station in a wireless communication system according to an embodiment of the disclosure may include receiving, from a central unit-control plane (CU-CP) of the base station, a first message including information indicating whether a remote user equipment (UE) is in a state of being connected through a sidelink relay, identifying, based on the information, information on data usage by means of the sidelink relay of the remote UE, and in case that a preconfigured condition is satisfied, transmitting, to the CU-CP, a second message including information on the data usage by means of the sidelink relay of the remote UE.

In addition, the method may further include in case that a connection state of the remote UE is changed from a connection through the sidelink relay to a radio interface connection with the base station, receiving, from the CU-CP, a fourth message including information indicating a state in which the connection through the sidelink relay is released, suspending calculation of the data usage by means of the sidelink relay of the remote UE, and transmitting, to the CU-CP, a fifth message including information on the data usage by means of the sidelink relay of the remote UE, the information being identified until a time point of the suspension of the calculation.

In addition, the first message may include at least one of a bearer context setup request message or a bearer context modification request message.

In addition, the information on the data usage by means of the sidelink relay of the remote UE may be a value calculated for each protocol data unit (PDU) session or each quality of service (QoS) flow.

In addition, the information on the data usage by means of the sidelink relay of the remote UE may include at least one of information associated with a start time point of performing data transmission or reception using the sidelink relay, information associated with an end time point of performing data transmission or reception using the sidelink relay, uplink data usage information, or downlink data usage information.

In addition, to solve the above-described problem, a central unit-control plane (CU-CP) of a base station in a wireless communication system according to an embodiment of the disclosure may include a transceiver, and a controller connected to the transceiver and configured to transmit, to a central unit-user plane (CU-UP) of the base station, a first message including information indicating whether a remote user equipment (UE) is in a state of being connected through a sidelink relay, in case that a preconfigured condition is satisfied, receive, from the CU-UP, a second message including information on data usage by means of the sidelink relay of the remote UE, and transmit, to an access and mobility management function (AMF), a third message including information on the data usage by means of the sidelink relay of the remote UE.

In addition, to solve the above-described problem, a central unit-user plane (CU-UP) of a base station in a wireless communication system according to an embodiment of the disclosure may include a transceiver, and a controller connected to the transceiver and configured to receive, from a central unit-control plane (CU-CP) of the base station, a first message including information indicating whether a remote user equipment (UE) is in a state of being connected through a sidelink relay, identify, based on the information, information on data usage by means of the sidelink relay of the remote UE, and in case that a preconfigured condition is satisfied, transmit, to the CU-CP, a second message including information on the data usage by means of the sidelink relay of the remote UE.

### Advantageous Effects of Invention

An embodiment of the disclosure provides a method in which in a mobile communication system, when a UE receives a mobile communication network service by performing communication connection with a mobile communication network by using a sidelink relay technology through a connection with a relay support UE, a usage time and usage of data services through the sidelink relay can be distinguished, and the distinguished data usage information through the sidelink relay is to be utilized for charging information, etc.

In addition, an embodiment of the disclosure is to provide a method in which a base station transfers, to a core network, a case where a UE is directly connected to a mobile communication base station and whether the UE is connected to the mobile communication base station through a sidelink relay, so as to change a connection policy, e.g., a QoS parameter configuration.

Advantageous effects obtainable from the disclosure may not be limited to the above mentioned effects, and other effects which are not mentioned may be clearly understood from the following descriptions by those skilled in the art to which the disclosure pertains.

### BRIEF DESCRIPTION OF DRAWINGS

FIG. 1 illustrates a structure of a next-generation mobile communication system according to an embodiment of the disclosure.

FIG. 2 is a signal flow chart illustrating a procedure of using control information signaling between a central unit (CU) and a distributed unit (DU) to enable transmission of a control signal and user data between a remote user equipment (remote UE) and a base station according to an embodiment.

FIG. 3A illustrates a process in which a remote user equipment (UE) performs a connection procedure with a base station through a relay support UE according to an embodiment of the disclosure.

FIG. 3B illustrates a process in which a remote user equipment (UE) performs a connection procedure with a base station through a relay support UE according to an embodiment of the disclosure.

FIG. 4 illustrates a process in which a remote user equipment (UE) performs a procedure of performing path switching to a radio interface connection with a base station in a state in which the remote UE is connected to the base station through a relay support UE according to an embodiment of the disclosure.

FIG. 5 illustrates an example of a message for transmitting state information of a remote user equipment to an AMF by a base station according to an embodiment of the disclosure.

FIG. 6A illustrates a process in which a remote user equipment (UE) performs a connection procedure with a base station through a relay support UE according to an embodiment of the disclosure.

FIG. 6B illustrates a process in which a remote user equipment (UE) performs a connection procedure with a base station through a relay support UE according to an embodiment of the disclosure.

FIG. 7 illustrates a process in which a remote user equipment (UE) performs a procedure of performing path switching to a radio interface connection with a base station in a state in which the remote UE is connected to the base station through a relay support UE according to an embodiment of the disclosure.

FIG. 8A illustrates an example of a message for transmitting state information of a remote user equipment to an AMF by a base station according to an embodiment of the disclosure.

FIG. 8B illustrates an example of a message for transmitting state information of a remote user equipment to an AMF by a base station according to an embodiment of the disclosure.

FIG. 9 illustrates a procedure of a base station, in which a UPF receives whether a remote user equipment receives a mobile communication service in a sidelink relay scheme so that the UPF can generate or suspend data usage information provided through a sidelink relay, according to an embodiment of the disclosure.

FIG. 10 illustrates a procedure of a UPF, in which the UPF receives whether a remote user equipment receives a mobile communication service in a sidelink relay scheme so that the UPF can generate or suspend data usage information provided through a sidelink relay according to an embodiment of the disclosure.

FIG. 11A illustrates a process in which a remote user equipment performs a connection procedure with a base station through a relay support UE in a separated base station structure according to an embodiment of the disclosure.

FIG. 11B illustrates a process in which a remote user equipment performs a connection procedure with a base station through a relay support UE in a separated base station structure according to an embodiment of the disclosure.

FIG. 12 illustrates a process in which a remote user equipment (UE) performs a procedure of performing path switching to a radio interface connection with a base station in a state in which the remote UE is connected to the base station through a relay support UE according to an embodiment of the disclosure.

FIG. 13A illustrates an example of a message for transmitting state information of a remote user equipment to a CU-UP of a base station by a CU-CP of the base station according to an embodiment of the disclosure.

FIG. 13B illustrates an example of a message for transmitting state information of a remote user equipment to a CU-UP of a base station by a CU-CP of the base station according to an embodiment of the disclosure.

FIG. 14A illustrates an example of a message for transmitting state information of a remote user equipment to a CU-CP of a base station by a CU-UP of the base station according to an embodiment of the disclosure.

FIG. 14B illustrates an example of a message for transmitting state information of a remote user equipment to a CU-CP of a base station by a CU-UP of the base station according to an embodiment of the disclosure.

FIG. 14C illustrates an example of a message for transmitting state information of a remote user equipment to a CU-CP of a base station by a CU-UP of the base station according to an embodiment of the disclosure.

FIG. 15A illustrates an example of a message for transmitting state information of a remote user equipment to an AMF by a CU-CP of a base station according to an embodiment of the disclosure.

FIG. 15B illustrates an example of a message for transmitting state information of a remote user equipment to an AMF by a CU-CP of a base station according to an embodiment of the disclosure.

FIG. 15C illustrates an example of a message for transmitting state information of a remote user equipment to an AMF by a CU-CP of a base station according to an embodiment of the disclosure.

FIG. 16 illustrates a procedure in which a CU-UP of a base station receives whether a remote user equipment (UE) receives a mobile communication service in a sidelink relay scheme so that the CU-UP of the base station can generate or suspend data usage information provided through a sidelink relay according to an embodiment of the disclosure.

FIG. 17 illustrates a procedure in which a CU-UP of a base station receives whether a remote user equipment (UE) receives a mobile communication service in a sidelink relay scheme so that the CU-UP of the base station can generate or suspend data usage information provided through a sidelink relay according to an embodiment of the disclosure.

FIG. 18 is a signal flow chart illustrating a procedure in which a 5GC receives whether a remote user equipment (UE) receives a mobile communication service in a sidelink relay scheme so as to change a connection policy in a process in which the remote UE performs connection procedure with a base station through a relay support UE according to an embodiment of the disclosure.

FIG. 19 illustrates a configuration of a UE according to an embodiment of the disclosure.

FIG. 20 illustrates a configuration of a network entity according to an embodiment of the disclosure.

### MODE FOR THE INVENTION

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

Hereinafter, the operation principle of the disclosure will be described in detail in conjunction with the accompanying drawings. The terms which will be described below are terms defined in consideration of the functions in the disclosure. They may be different according to users, intentions of the users, or customs, and therefore, the definitions of the terms should be made based on the contents throughout the specification.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the disclosure, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

Particular terms as used in the following description are merely provided to help understanding pf the disclosure, and other types of terms may be used without departing from the scope of the technical idea of the disclosure.

As used herein, terms referring to network entities, terms referring to messages, terms referring to identification information, and the like are illustratively used for the sake of descriptive convenience. Therefore, the disclosure is not limited by the terms as described below, and other terms referring to subjects having equivalent technical meanings may also be used.

In the following description, the disclosure will be described using terms and names defined in the 5G system standards for the sake of descriptive convenience, but the disclosure is not limited by these terms and names and may be applied in the same way to systems that conform other standards.

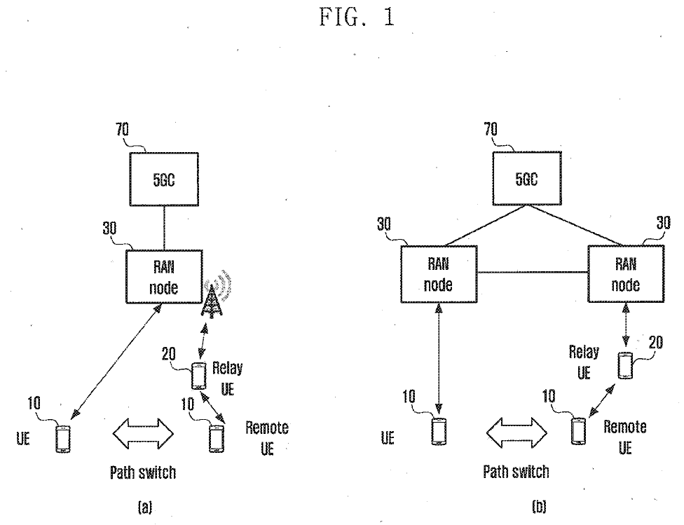

FIG. 1 illustrates a structure of a next-generation mobile communication system according to an embodiment of the disclosure.

Referring to FIG. 1, an example of a structure of a next-generation mobile communication system in which a terminal (or a user equipment (UE)) 10 is connected to a mobile communication base station 30 and thus can receive a mobile communication service through a sidelink relay technology is illustrated. A RAN node 30 indicated in this structure may be a mobile communication base station connected to a core network (CN) 70 such as a 5G core network (5GC). For example, the RAN mode 30 may be an LTE eNB or an NR gNB. Part (a) of FIG. 1 illustrates that a path switch between a direct connection and an indirect connection through a sidelink relay is possible as in a case where a UE 10 receives a mobile communication service through a direction connection or through a sidelink relay technology by using another UE 20 connected to the same mobile communication base station 30. Part (b) of FIG. 1 illustrates that a path switch between a direct connection and an indirect connection to another base station through a sidelink relay is possible as in a case where a UE 10 receives a mobile communication service through a direct connection with a mobile communication base station 30 or through a sidelink relay technology by using another UE 20 connected to another mobile communication base station 30.

In part (a) of FIG. 1, a user equipment 10 may receive a mobile communication service through a communication radio interface (e.g., a Uu interface) with a mobile communication base station 30, or may operate as a remote user equipment (UE) (a remote UE or a remote terminal) 10 and may be connected to a relay support user equipment (UE) (a relay UE or a relay terminal) 20 through a UE-to-UE communication radio interface (e.g., a PC5 interface), and the relay support UE 20 may be connected to a base station (RAN node) 30 through a radio interface (e.g., a Uu interface) to receive a mobile communication service. The UE 10 may support a path switch operation of switching between a connection to mobile communication through a communication radio interface (e.g., a Uu interface) and a connection to mobile communication of a relay support 20 through a communication radio interface (e.g., a Uu interface) and a UE-to-UE direct communication radio interface (e.g., a PC5 interface) by using the relay support UE 20.

In part (b) of FIG. 1, a path switch operation in a case of connection switching from a state in which a user equipment (UE) 10 receives a mobile communication service through a communication radio interface (e.g., a Uu interface) with a mobile communication base station 30 to a state in which the UE 10 receives the mobile communication service by using a UE-to-UE direction communication radio interface (e.g., a PC5 interface) through a relay support UE (relay UE) 20 connected to a RAN node 30 different from a connected RAN node 30 and a communication radio interface (e.g., a Uu interface) connection with mobile communication of the relay support UE 20, and in a case where the UE 10 performs connection switching from a relay connection to a base station direct connection, may be supported.

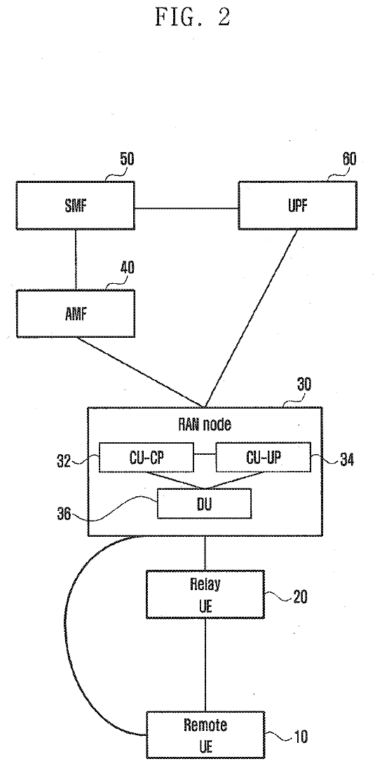

FIG. 2 illustrates an example of a structure of a next-generation mobile communication system according to an embodiment of the disclosure.

Referring to FIG. 2, a signal flow chart illustrating a procedure of using control information signaling between a central unit (CU) and a distributed unit (DU) to enable transmission of a control signal and user data between a remote user equipment (remote UE) 10 and a base station 30 according to an embodiment of the disclosure is illustrated. A radio access network (RAN) node 30 indicated in this structure may be a mobile communication base station connected to a core network (CN) such as a 5G core network (5GC). For example, the RAN node 30 may be an LTE eNB, an NR gNB, or the like. The RAN node 30 is connected to a core network through an interface such as a next-generation (NG) interface, and may be also connected to another base station (not shown) through an interface such as an Xn interface. In addition, when the RAN node 30 has a separated base station structure, the base station 30 may include central units (CUs) 32 and 34 and a distributed unit (DU) 36. The central units (CUs) may include a CU-control plane (CU-CP) 32 and a CU-user plane (CU-UP) 34. In an embodiment, the RAN mode 30 may include one CU-UP 32, and one or more CU-UPs 34 and one or more DUs 36, which are connected to the CU-CP, or may include other combinations thereof. The CU-CP 32, the CU-UP 34, and the DU 36 may share and support base station functions, respectively. For example, the CU-CP 32 processes an interface between a radio resource control (RRC) and a base station, e.g., an X2 interface and an Xn interface, an interface between the base station 30 and a core network (CN), e.g., an NG interface and an SI interface, and the like. The CU-UP 34 processes a user data packet by supporting a function such as a packet data convergence protocol (PDCP) and a service data adaptation protocol (SDAP). The DU 216 may perform a function of radio transmission and reception with a UE by supporting a radio link control (RLC) layer, a medium access control (MAC) layer, and a physical (PHY) layer. An interface between base station internal functions, such as an F1 or WI interface, may be connected between the CUS 32 and 34 and the DU 36. In an embodiment, each DU 36 may be separated into a part supporting the RLC/MAC/high-PHY layers and a part supporting low-PHY/RF layers.

FIG. 2 illustrates a 5GC core network (5GC) among core networks. The SGC may include an access and mobility management function (AMF) 40, a session management function (SMF) 50, a user plane function (UPF) 60, and the like, and other 5GC functions (network entities/functions), and the like, which do not influence the disclosure, are not illustrated.

In FIG. 2, a remote user equipment (UE) 10 is connected to a relay support user equipment (relay UE) 20 through a UE-to-UE direct communication radio interface (e.g., a PCS interface), and the relay support UE 20 is connected to a base station (RAN node) 30 through a radio interface (e.g., a Uu interface). The remote UE 10 may transmit or receive a control signal (control plane signaling) (e.g., RRC signaling) and user data (user plane data) (e.g., an Internet protocol packet) by performing a communication connection with the base station 30 through the relay support UE (relay UE) 20. In addition, the remote UE 10 may perform a connection operation through a radio interface (e.g., a Uu interface) with the base station 30.

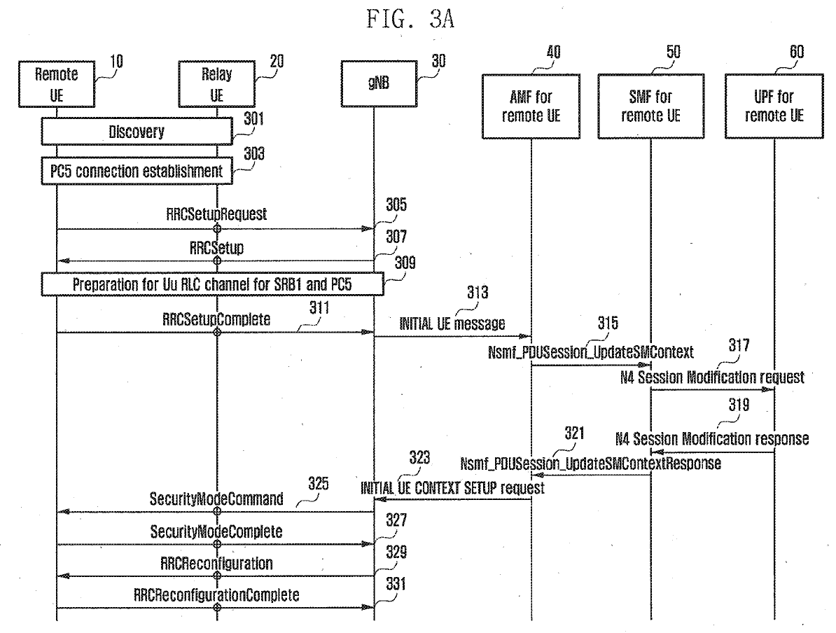

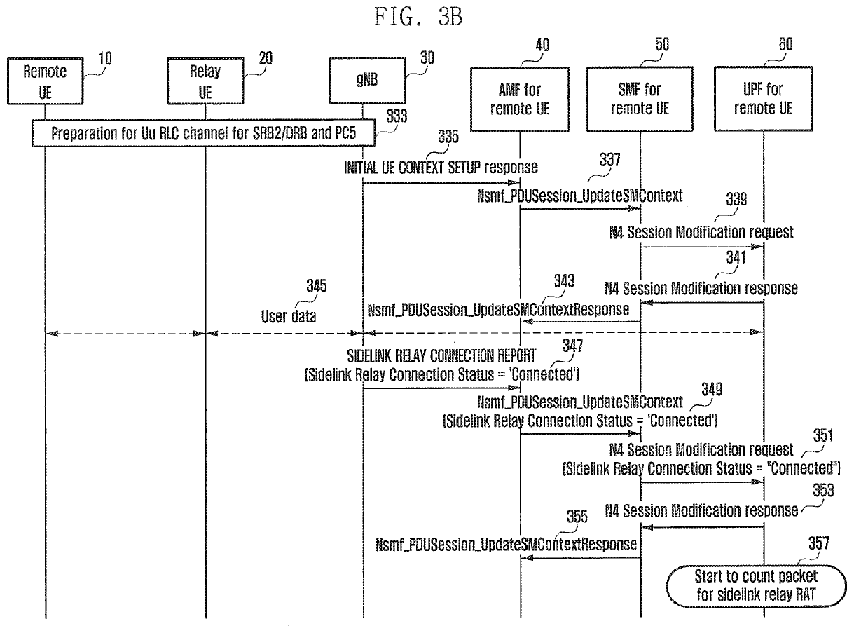

FIGS. 3A and 3B are signal flow charts illustrating a procedure in which a UPF 60 receives whether a remote user equipment (UE) 10 receives a mobile communication service in a sidelink relay scheme so that the UPF 60 can generate data usage information provided through a sidelink relay in a process in which the remote UE 10 performs a connection procedure with a base station 30 through a relay support UE (relay UE) 20 according to an embodiment of the disclosure. In FIGS. 3A and 3B, one or more SMFs 50 and one or more UPFs 60 for providing a mobile communication service of the remote UE 10 may be used, but the signal flow charts show only a case where one SMF 50 and one UPF 60 are used, and for a signal procedure from an AMF 40, the same signal procedure may be used also in a case where several SMFs and UPFs are used.

Referring to FIGS. 3A and 3B, in operations 301 and 303, for direct communication with a relay support UE (relay UE) 20, a remote user equipment (UE) 10 may perform a PC5 connection establishment procedure and a discovery procedure for a PC5 link connection. In operation 303, a configuration for allowing the remote UE 10 to communicate with a base station 30 in a mobile communication network through the relay UE 20 may be included.

In operation 305, the remote UE 10 may transfer, to the relay UE 20 by using a PC5 link, an RRC connection request message (e.g., an RRCSetupRequest message) to be transmitted to the base station 30, and the relay UE 20 may transmit the RRC connection request message (e.g., the RRCSetupRequest message) to the base station 30. When the base station 30 receives the RRC connection request message of the remote UE 10 through the relay UE 20, the base station may generate an RRC connection configuration message (e.g., an RRCSetup message) for the remote UE 10 and transmit the same to the remote UE 10 through the relay UE 20 in operation 307. In addition, in operation 309, the remote UE 10, the relay UE 20, and the base station 30 may perform a signal transmission and reception procedure and an operation for configuring a Uu RLC channel for signaling radio bearer 1 (SRB1) and a PC5 connection. Operation 309 corresponds the well-known technology and a detailed procedure is omitted. In operation 311, the remote UE 10 may transmit an RRC connection configuration completion message (e.g., an RRCSetupComplete message) to the base station 30 through the relay support UE 20. The base station 30 having received the RRC connection configuration completion message (e.g., the RRCSetupComplete message) from the remote UE 10 may transmit, in operation 313, an initial UE message to the AMF 40 that is selected and operated for servicing the remote UE 10 of the SGC, and may perform, up to operation 343, a sidelink relay connection mode configuration procedure through the relay UE 20 for the provision of the mobile communication service of the remote UE 10. The AMF 40 having received the initial UE message from the base station 30 in operation 313 may identify the SMF 50 for a protocol data unit (PDU) session connection for the service of the remote UE 10, and then may transmit Nsmf_PDUSession_UpdateSMContext to the corresponding SMF 50 in operation 315. In addition, in operation 317, the SMF 50 may identify again the UPF 60 for the corresponding PDU session service, and then transmit an N4 session modification request to the corresponding UPF 60. In operation 319, the UPF 60 may respond to the SMF 50 with an N4 session modification response, and the SMF 50 having received the same may transmit Nsmf_PDUSession_UpdateSMContextResponse to the AMF 40 in operation 321. The AMF 40 may receive the message from all SMFs for the service of the remote UE 10 in operation 321, and then may transmit an initial UE context setup request message to the base station 30 in operation 323 to request configuration of context and a radio resource for the remote UE 10 from the base station 30. The base station 30 having received the initial UE context setup request message from the AMF 40 may exchange, with the remote UE 10 through the relay UE 20, an RRC SecurityModeCommand message and an RRC SecurityModeComplete message for a radio period encryption configuration in operation 325 and 327. In addition, in operations 329 and 331, the base station 30 may transmit an RRC reconfiguration message (e.g., an RRCReconfiguration message) to the remote UE 10 through the relay UE 20, and may receive an RRC reconfiguration completion message (e.g., an RRCReconfigurationComplete message) from the remote UE 10 (through the relay UE 20), In operation 333, the remote UE 10, the relay UE 20, and the base station 30 may perform a signal transmission and reception procedure and an operation for configuring a Uu RLC channel for one or more data radio bearers (DRBs) and signaling radio bearer 2 (SRB2) and a PC5 connection. The operation corresponds to the well-known technology, and thus a detailed procedure is omitted. After the completion of the configuration, in operation 335, the base station 30 may transmit an initial UE context setup response message to the AMF 40 to notify the AMF 40 of the contents of the configuration of the context and radio resource for the remote UE 10. The AMF 40 may transmit, in operation 337, Nsmf_PDUSession_UpdateSMContext to the SMFs 50, the SMF 50 may transmit, in operation 339, an N4 session modification request to the UPF 60, and the UPF 60 may respond, in operation 341, to the SMF 50 with an N4 session modification response. In operation 343. the SMF 50 may transmit Nsmf_PDUSession_UpdateSMContextResponse to the AMF 40. When operations up to operation 343 have been performed, the connection procedure for the remote UE 10 has been completed, and a data packet associated with the remote UE 10 can be transmitted or received as in operation 345.

The base station 30 may identity that the remote UE 10 is connected through the relay UE 20, and in this case, the base station 30 may transmit a sidelink relay connection report message to the AMF 40 in operation 347. In addition, this message may include information (e.g., configuring a sidelink relay connection status IE to be “Connected”) notifying that the UE 10 is in a sidelink relay connected state, and according to an embodiment, identifier information of the relay UE 20 may be included. The AMF 40 having received the message may transmit Nsmf_PDUSession_UpdateSMContext to the SMF 50 in operation 349. The Nsmf_PDUSession_UpdateSMContext message may include information (e.g., configuring a sidelink relay connection status to be “Connected”) notifying of a sidelink relay connected state, and according to an embodiment, identifier information of the relay UE 20 may be included. The SMF 50 may transmit an N4 session modification request to the UPF 60 in operation 351. The N4 session modification request message may include information (e.g., configuring a Sidelink Relay Connection Status IE to be “Connected”) notifying of a sidelink relay connected state, and according to an embodiment, identifier information of the relay UE 20 may be included. The UPF 60 having received the N4 session modification request in operation 351 may start counting a user data packet service of the remote UE 10 as data usage by means of the sidelink relay in operation 357, and the data usage information corresponds to counting a packet amount for each UE, PDU session, or quality of service (QoS) flow, or the data usage information may be generated using a connection usage time or other methods. In operation 353, the UPF 60 may respond by transmitting an N4 session modification response to the SMF 50, and in operation 355, the SMF 50 may transmit Nsmf_PDUSession_UpdateSMContextResponse to the AMF 40.

According to an embodiment, the sidelink relay connection report message transmitted to the AMF 40 by the base station 30 in operation 347 may be transmitted to the AMF 40 by the base station 30, simultaneously with the initial UE context setup response message transmitted to the AMF 40 by the base station 30 in operation 335, or immediately after operation 335. In this case, before operation 337 in which the AMF 40 transmits Nsmf_PDUSession_UpdateSMContext to the SMF 50, the AMF 40 may receive the sidelink relay connection report message from the base station 30. When the AMF 40 receives the sidelink relay connection report message from the base station 30 before operation 337, the Nsmf_PDUSession_UpdateSMContext transmitted to the SMF 50 by the AMF 40 in operation 337 may include information (e.g., configuring a sidelink relay connection status to be “Connected) notifying a sidelink relay connected state and identifier information of the relay UE 20, and in operation 339, the SMF 50 may include, in the N4 session modification request transmitted to the UPF 60, information (e.g., configuring a sidelink relay connection status to be “Connected”) notifying of a sidelink relay connected state and identifier information of the relay UE 20. Accordingly, when the AMF 40 receives the sidelink relay connection report message from the base station 30 before operation 337, the sidelink relay connection state information is transferred from the AMF 40 to the SMF 50 and from the SMF 50 to the UPF 60 again in operations 337 and 339, and thus additional procedures from operations 349 to 355 may not be performed.

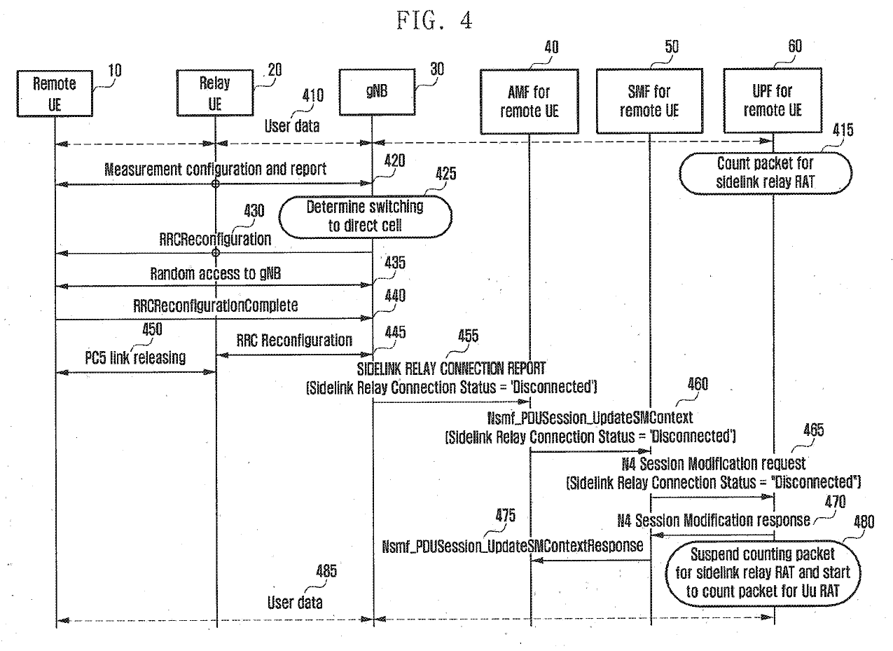

FIG. 4 is a signal flow chart illustrating a procedure in which a UPF 60 receives whether a remote user equipment (UE) 10 receives a mobile communication service in a sidelink relay scheme so that the UPF 60 can suspend generation of data usage information provided through a sidelink relay in a process in which the remote UE 10 performs a procedure of performing path switch to a radio interface (e.g., a Uu interface) connection with a base station 30 from the state in which the remote UE 10 is connected to the base station 30 through a relay support UE (replay UE) 20 according to an embodiment of the disclosure. In FIG. 4, one or more SMFs 50 and one or more UPFs 60 for providing a mobile communication service of the remote UE 10 may be used, but the signal flow chart shows only a case where one SMF 50 and one UPF 60 are used, and for a signal procedure from an AMF 40, the same signal procedure may be used also in a case where several SMFs and UPFs are used. In addition, FIG. 4 illustrates a procedure of a case where the remote UE 10 and the relay UE 20 are connected to the same base station 30, but the procedure of FIG. 4 can be used also in a case where the remote UE 10 and the relay UE 20 are connected to different base stations from each other, and only an additional procedure for handover between the base stations may be added and operated.

Referring to FIG. 4, in the state in which the remote UE 10 is connected to the base station 30 through the relay UE 20 and receives a mobile communication service, the remote UE 10 may perform transmission or reception of a data packet of the remote UE 10 through the relay UE 20 as in operation 410. The UPF 60 may count a user data packet service of the remote UE 10 as data usage by means of a sidelink relay as in operation 415. In operation 420, after measuring a signal according to a measurement configuration for relay support candidate UEs 20 and a neighboring base station configured by the base station 30, the remote UE 10 reports a result of the measurement to the base station 30. The base station 30 having received measurement report information from the remote UE 10 may determine to change to a radio interface (e.g., a Uu interface) connection of the remote UE 10 with the base station 30 in operation 425, and may perform an indirect-to-direct path switch procedure for changing a connection path of the remote UE 10 in operation 430 to operation 450. When the base station 30 determines the path switch in operation 425, the base station 30 may transmit, in operation 430, an RRC reconfiguration message (e.g., an RRCReconfiguration message) to the remote UE 10 through the relay UE 20 for the change of the connection path of the remote UE 10. The remote UE 10 having received the RRC reconfiguration message (e.g., the RRCReconfiguration message) may perform, based on the RRC reconfiguration message (e.g., the RRCReconfiguration message), a random access procedure to the base station 30 in operation 435, and when the random access is completed, may transmit an RRC reconfiguration completion message (e.g., an RRCReconfigurationComplete message) to the base station 30 in operation 440. The base station 30 having received the reconfiguration completion message (e.g., the RRCReconfigurationComplete message) from the remote UE 10 may perform an RRC connection reconfiguration procedure with the relay UE 20 in operation 445 to release sidelink relay transmission of the remote UE 10, and may perform a connection release procedure for a PC5 link with the remote UE 10 in operation 450.

When the remote UE 10 identifies, in operation 440, that the connection procedure to the radio interface (e.g., the Uu interface) with the base station 30 has been completed, the base station 30 may transmit a sidelink relay connection report message to the AMF 40 in operation 455, and the message may include information (e.g., configuring a sidelink relay connection status IE to be “Disconnected”) notifying that the remote UE 10 is in a sidelink relay connection released state. According to an embodiment, the message may include identifier information of the relay UE 20. The AMF 40 having received the message may transmit Nsmf_PDUSession_UpdateSMContext to the SMF 50 in operation 460. The Nsmf_PDUSession_UpdateSMContext message may include information (e.g., configuring a sidelink relay connection status to be “Disconnected”) notifying a sidelink relay connection released state. According to an embodiment, the message may include identifier information of the relay UE 20. The SMF 50 may transmit an N4 session modification request to the UPF 60 in operation 465. The NF session modification request message may include information (e.g., configuring a Sidelink Relay Connection Status IE to be “Disconnected”) notifying of a sidelink relay connection released state. According to an embodiment, the message may include identifier information of the relay UE 20. The UPF 60 having received the N4 session modification request in operation 465 suspends counting the user data packet service of the remote UE 10 as data usage by means of a sidelink relay, and starts to count the user data packet service of the remote UE 10 as data used for a radio interface (e.g., a Uu interface) with a normal UE and a base station, in operation 480. The data usage information corresponds to counting a packet amount for each UE, PDU session, or quality of service (QoS) flow, or the data usage information may be generated using a connection usage time or other methods. In operation 470, the UPF 60 may respond by transmitting an N4 session modification response to the SMF 50, and in operation 475, the SMF 50 may transmit Nsmf_PDUSession_UpdateSMContextResponse to the AMF.

After the remote UE 10 completes the connection procedure through a radio interface (e.g., a Uu interface) with the base station 30 in operation 440, the data packet of the remote UE 10 may be transferred by means of the radio interface (e.g., the Uu interface) with the UE 10 and the base station 30 as in operation 485.

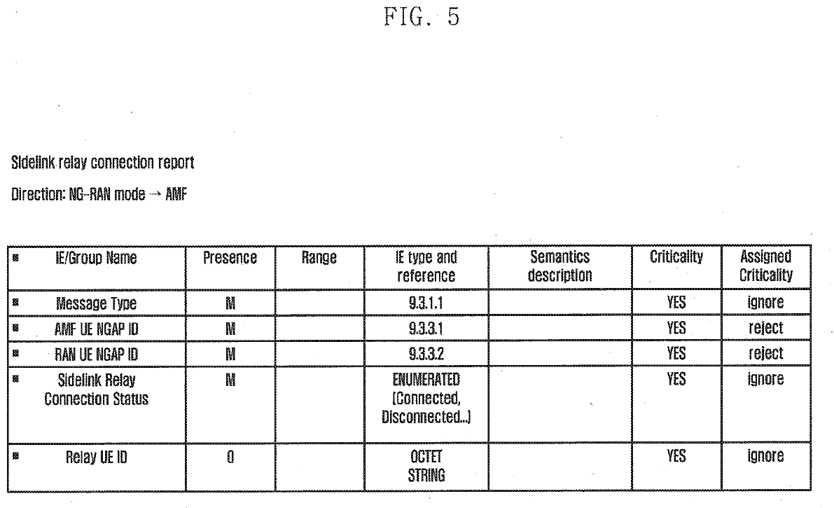

FIG. 5 illustrates an example of a message for transmitting state information of a remote user equipment to an AMF by a base station according to an embodiment of the disclosure.

Referring to FIG. 5, an example of a configuration of an NGAP message (e.g., a sidelink relay connection report message) used to transfer sidelink relay connection state information of a remote user equipment (UE) 10 to an AMF 40 of the 5GC by a base station 30, the message being used in operation 347 of FIGS. 3A and 3B and operation 455 of FIG. 4, is illustrated. The NGAP message (e.g., the sidelink relay connection report message) used to transfer the sidelink relay connection state information includes message type information for distinguishing a message type and an identifier for distinguishing a UE in UE-associated signaling, e.g., an AMF UE NGAP ID and a RAN UE NGAP ID. In addition, sidelink relay connection status for the disclosure may be included, for example, the sidelink relay connection status information may include “Connected” and “Disconnected” state information, and different terms may be used for the same. In addition, only one value between “Connected” and “Disconnected” may be included, and other additional information may be included. The message may also include an identifier of the remote UE 20 when the remote UE is connected through the relay UE 20, and the identifier of the relay UE 20 may be transferred in the form of an integer or other forms, in addition to the form of an OCTET string. FIG. 5 illustrates an example of the NGAP message (e.g., the sidelink relay connection report message) used to transfer sidelink relay connection state information, but the sidelink relay connection state information of the remote UE 10 and the identifier information of the remote UE 20, which are included in FIG. 5, may be included in the already used NGAP message and transmitted to the AMF 40 by the base station 30. In addition, the sidelink relay connection state information of the remote UE 10 and the identifier information of the relay UE 20, which are included in FIG. 5, may be also included in the Nsmf_PDUSession_UpdateSMContext in operation 349 and the N4 session modification request in operation 351 of FIGS. 3A and 3B and the Nsmf_PDUSession_UpdateSMContext in operation 460 and the N4 session modification request in operation 465 of FIG. 4, and the form of being included in the message may vary according to a message structure form used in each case.

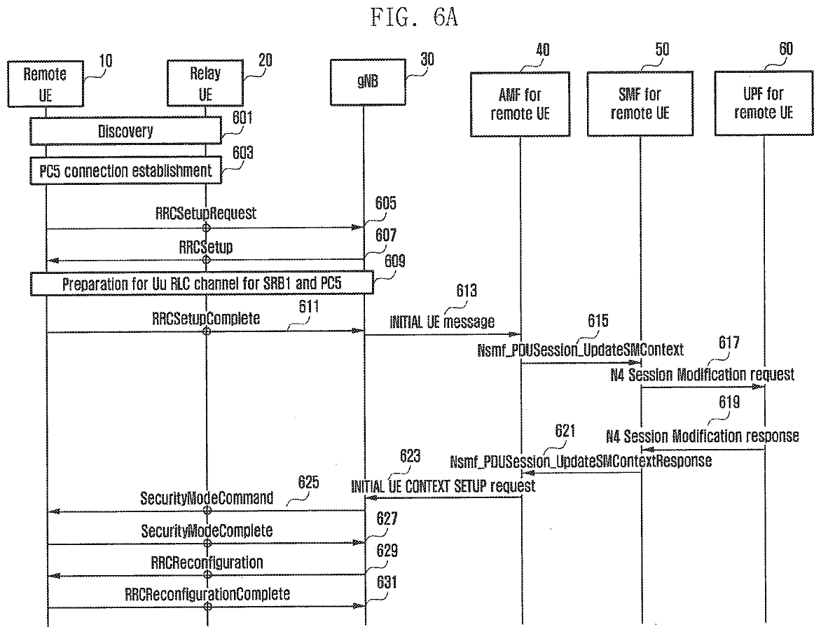

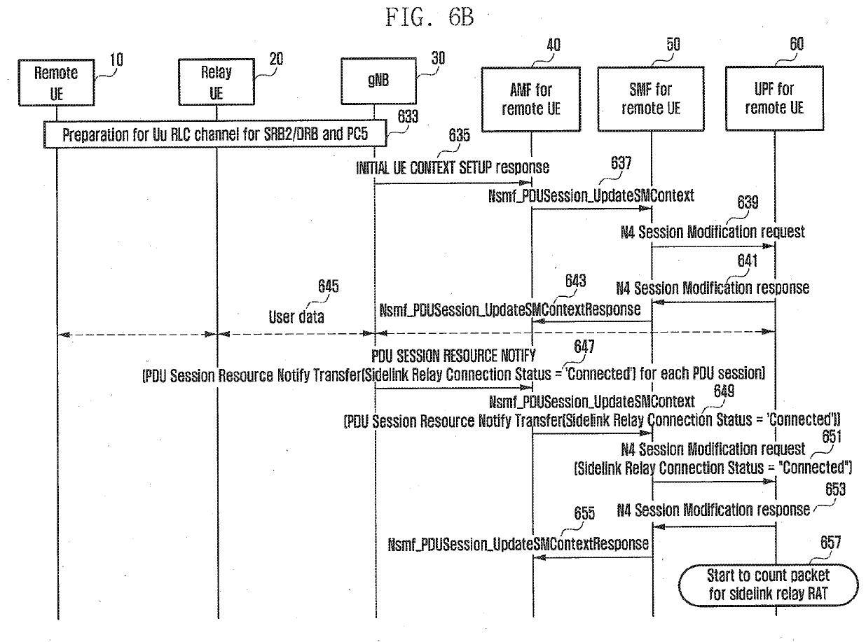

FIGS. 6A and 6B are signal flow charts illustrating a procedure in which a UPF 60 receives whether a remote user equipment (UE) 10 receives a mobile communication service in a sidelink relay scheme so that the UPF 60 can generate data usage information provided through a sidelink relay in a process in which the remote UE 10 performs a connection procedure with a base station 30 through a relay UE 20 according to an embodiment of the disclosure. In FIGS. 6A and 6B, one or more SMFs 50 and one or more UPFs 60 for providing a mobile communication service of the remote UE 10 may be used, but the signal flow charts show only a case where one SMF 50 and one UPF 60 are used, and for a signal procedure from an AMF 40, the same signal procedure may be used also in a case where several SMFs and UPFs are used. In the embodiments of FIGS. 3A and 3B, the base station 30 transfers sidelink relay connection state information of the remote UE 10 to the AMF 40, adds the sidelink relay connection state information of the remote UE 10 to a message transferred to the corresponding SMF 50 after the AMF 40 processes the related message, and transfers the same. On the other hand, in the embodiments of FIGS. 6A and 6B, the base station 30 adds sidelink relay connection state information to the contents of the message transferred to the SMF 50 through the AMF 40 and transfers the same, and the AMF 40 may simply transfer the information received from the base station 30 to the SMF 50. In the embodiments of FIGS. 3A and 3B, the AMF 40 needs to perform additional message processing whereas the sidelink relay connection state information of the UE is included in the message transferred to the AMF 40 by the base station 30 one time, but in the embodiments of FIGS. 6A and 6B, no additional message processing of the AMF 40 occurs, but sidelink relay connection state information of the UE needs to be redundantly included in the message transferred to the SMF 50 through the AMF 40 by the base station for each PDU session, and thus a message information amount may be increased.

Referring to FIGS. 6A and 6B, the process from operations 601 to 645 is identical to the procedure from operations 301 to 345 in FIGS. 3A and 3B. In the process from operations 601 to 645, the base station 30 may identify that the remote UE 10 is connected through the relay UE 20. In this case, the base station 30 may transmit a PDU session resource notify message to the AMF 40 in operation 647. The PDU session resource notify message may include a PDU Session Resource Notify Transfer IE to be transferred to the SMF 50 for each PDU session. The PDU Session Resource Notify Transfer IE may include information (e.g., configuring a Sidelink Relay Connection Status IE to be “Connected”) notifying that the remote UE 10 is in a sidelink relay connected state, and according to an embodiment, identifier information of the relay UE 20 may be included. While transmitting Nsmf_PDUSession_UpdateSMContext to the SMF 50 in operation 649, the AMF 40 having received the PDU session resource notify message from the base station 30 in operation 647 may include the same PDU Session Resource Notify Transfer IE information for the PDU session handled by the SMF 50, included in the PDU session resource notify message, and transfer the same, the PDU Session Resource Notify Transfer IE information may include information (e.g., configuring a sidelink relay connection status to be “Connected”) notifying of a sidelink relay connected state, and according to an embodiment, the PDU Session Resource Notify Transfer IE information may include identifier information of the relay UE 20. The SMF 50 may transmit an N4 session modification request to the UPF 60 in operation 651. The N4 session modification request message may include information (e.g., configuring a sidelink relay connection status to be “Connected”) notifying of a sidelink relay connected state, and according to an embodiment, identifier information of the relay UE 20 may be included. The UPF 60 having received the N4 session modification request in operation 651 may start to count a user data packet service of the remote UE 10 as data usage by means of a sidelink relay in operation 657, and the data usage information corresponds to counting a packet amount for each UE, PDU session, or quality of service (QOS) flow, or the data usage information may be generated using a connection usage time or other methods. The UPF 60 responds by transmitting the N4 session modification response to the SMF 50 in operation 653, and the SMF 50 may transmit Nsmf_PDUSession_UpdateSMContextResponse to the AMF 40 in operation 655.

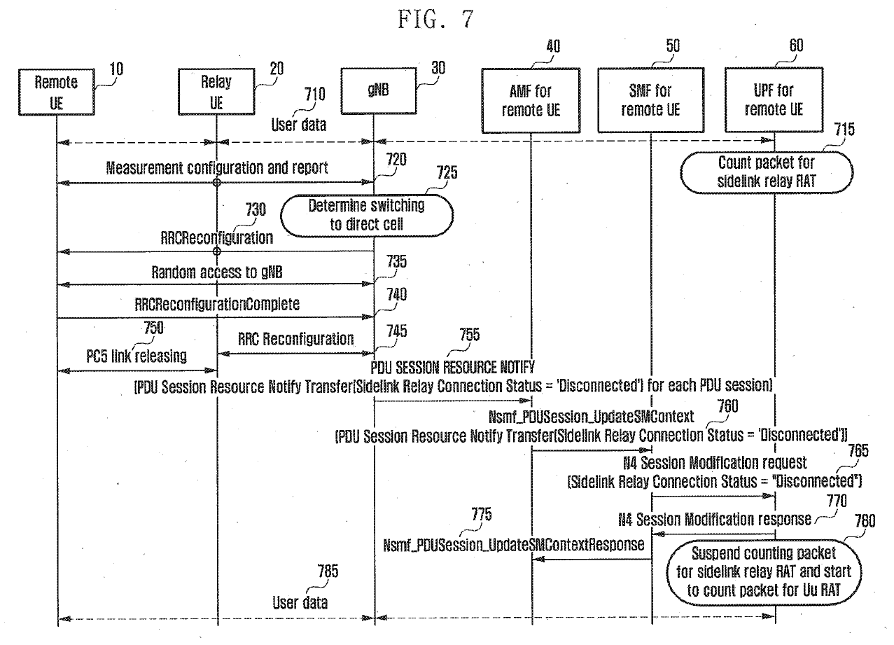

FIG. 7 is a signal flow chart illustrating a procedure in which a UPF 60 receives whether a remote user equipment (UE) 10 receives a mobile communication service in a sidelink relay scheme so that the UPF 60 can suspend generation of data usage information provided using a sidelink relay in a process in which the remote UE 10 performs path switch to a radio interface (e.g., a Uu interface) connection with a base station 30 from the state in which the remote UE 10 is connected to the base station 30 through a relay user equipment (UE) 20. In FIG. 7, one or more SMFs 50 and one or more UPFs 60 for providing a mobile communication service of the remote UE 10 may be used, but the signal flow chart shows only a case where one SMF 50 and one UPF 60 are used, and for a signal procedure from an AMF 40, the same signal procedure may be used also in a case where several SMFs and UPFs are used. In addition, FIG. 7 illustrates a procedure of a case where the remote UE 10 and the relay UE 20 are connected to the same base station 30, but the procedure of FIG. 7 can be used also in a case where the remote UE 10 and the relay UE 20 are connected to different base stations from each other, and only an additional procedure for handover between the base stations may be added and operated. In the embodiment of FIG. 4, the base station 30 transfers sidelink relay connection state information of the remote UE 10 to the AMF 40, adds the sidelink relay connection state information of the remote UE 10 to a message transferred to the corresponding SMF 50 after the AMF 40 processes the related message, and transfers the same. On the other hand, in the embodiment of FIG. 7, the base station 30 adds sidelink relay connection state information to the contents of the message transferred to the SMF 50 through the AMF 40 and transfers the same, and the AMF 40 simply transfers the information received from the base station 30 to the SMF 50. In the embodiment of FIG. 4, the AMF 40 needs to perform additional message processing whereas the sidelink relay connection state information of the UE is included in the message transferred to the AMF 40 by the base station 30 one time, but in the embodiment of FIG. 7, no additional message processing of the AMF 40 occurs, but sidelink relay connection state information of the UE needs to be redundantly included in the message transferred to the SMF 50 through the AMF 40 by the base station for each PDU session, and thus a message information amount may be increased.

Referring to FIG. 7, the process from operations 710 to 750 is identical to the procedure from operations 410 to 450 in FIG. 4. When the remote UE 10 identifies, in operation 740, that the connection procedure with the base station 30 through a radio interface (e.g., a Uu interface) has been completed, the base station 30 may transmit a PDU session resource notify message to the AMF 40 in operation 755. In addition, the PDU session resource notify message may include a PDU Session Resource Notify Transfer IE to be transferred to the SMF 50 for each PDU session. The PDU Session Resource Notify Transfer IE may include information (e.g., configuring a Sidelink Relay Connection Status IE to be “Disconnected”) notifying that the remote UE 10 is in a sidelink relay connection released state. According to an embodiment, the PDU Session Resource Notify Transfer IE may include identifier information of the relay UE 20, While transmitting Nsmf_PDUSession_UpdateSMContext to the SMF 50 in operation 760, the AMF 40 having received the PDU session resource notify message from the base station 30 in operation 755 may include the same PDU Session Resource Notify Transfer IE information for the PDU session handled by the SMF 50, included in the PDU session resource notify message, and transfer the same, the PDU Session Resource Notify Transfer IE information may include information (e.g., configuring a sidelink relay connection status to be “Disconnected”) notifying of a sidelink relay connection released state, and according to an embodiment, the PDU Session Resource Notify Transfer IE information may include identifier information of the relay UE 20. The SMF 50 may transmit an N4 session modification request to the UPF 60 in operation 765. The N4 session modification request message may include information (e.g., configuring a sidelink relay connection status to be “Disconnected”) notifying of a sidelink relay connection released state, and according to an embodiment, identifier information of the relay UE 20 may be included. The UPF 60 having received the N4 session modification request in operation 765 suspends counting the user data packet service of the remote UE 10 as data usage by means of a sidelink relay, and starts to count the user data packet service of the remote UE 10 as data used for a radio interface (e.g., a Uu interface) with a normal UE and a base station, in operation 780. The data usage information corresponds to counting a packet amount for each UE, PDU session, or quality of service (QOS) flow, or the data usage information may be generated using a connection usage time or other methods. The UPF 60 responds by transmitting the N4 session modification response to the SMF 50 in operation 770, and the SMF 50 may transmit Nsmf_PDUSession_UpdateSMContextResponse to the AMF 40 in operation 775.

After the remote UE 10 completes the connection procedure through a radio interface (e.g., a Uu interface) with the base station 30 in operation 740, the data packet of the remote UE 10 may be transferred by means of the radio interface (e.g., the Uu interface) with the UE 10 and the base station 30 as in operation 785.

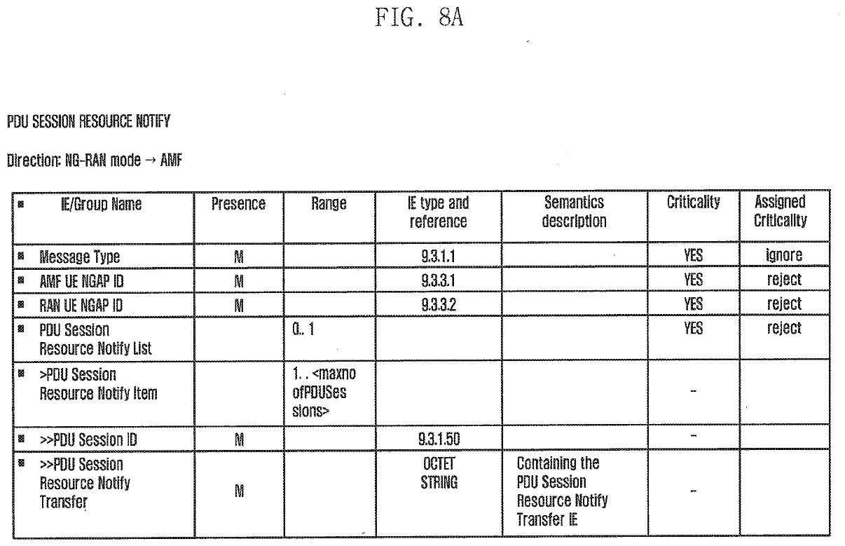

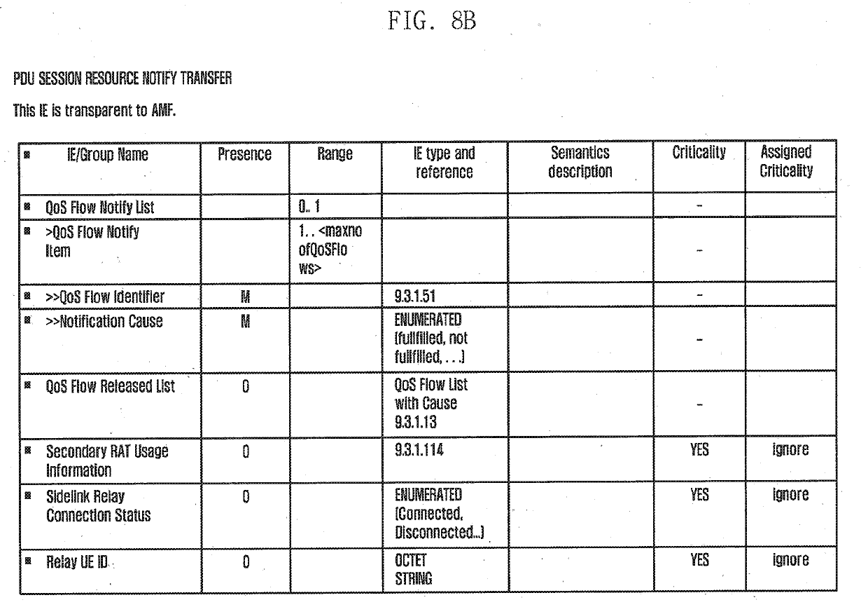

FIGS. 8A and 8B illustrate an example of a message for transmitting state information of a remote user equipment to an AMF by a base station according to an embodiment of the disclosure.

Referring to FIGS. 8A and 8B, an example of a configuration of an NGAP message (e.g., a PDU session resource notify message) used to transfer sidelink relay connection state information of a remote user equipment (UE) to an SMF 50 through an AMF 40 of the 5GC by a base station 30, the message being used in operation 647 of FIGS. 6A and 6B and operation 755 of FIG. 4, is illustrated. The NGAP message (e.g., the PDU session resource notify message) used to transfer the sidelink relay connection state information, shown in FIG. 8A, includes a PDU Session Resource Notify Transfer IE to be transferred to the SMF 50 by the base station 30. The PDU Session Resource Notify Transfer IE shown in FIG. SB may include sidelink relay connection status information for the disclosure, for example, the sidelink relay connection status information may include “Connected” and “Disconnected” state information, and different terms may be used for the same. In addition, only one value between “Connected” and “Disconnected” may be included, and other additional information may be included. This PDU Session Resource Notify Transfer IE may also include an identifier of the remote UE 20 when the remote UE is connected through the relay UE 20, and the identifier of the relay UE 20 may be transferred in the form of an integer or other forms, in addition to the form of an OCTET string. FIGS. 8A and 8B illustrate an example of an NGAP message (e.g., a sidelink relay connection report message) used to transfer sidelink relay connection state information, but the sidelink relay connection state information of the remote UE 10 and the identifier information of the remote UE 20, which are included in FIGS. 8A and 8B, may be defined and included in the already used other NGAP message or a new NGAP message and transmitted to the AMF 40 by the base station 30.

In addition, as illustrated in FIG. 8A, the PDU session resource notify message may include a PDU session resource notify list, and the PDU session resource notify list may include a PDU Session Resource Notify Transfer IE for each PDU session. Accordingly, a PDU session ID for identifying a PDU session corresponding to each PDU Session Resource Notify Transfer IE may be included in the PDU session resource notify message.

FIG. 8B illustrates that the sidelink relay connection status information may be configured for each PDU session. However, in another embodiment of the disclosure, the sidelink relay connection status information may be configured for each QoS flow. For example, to indicate the sidelink relay connection status for each QoS flow, a PDU Session Resource Notify Transfer IE may be configured so that the sidelink relay connection status information is included in a QoS flow notify item included in a QoS flow notify list. For example, the PDU Session Resource Notify Transfer IE may be configured like QOS flow notify list >QOS flow notify item >>QoS flow identity >>notification cause >>sidelink relay connection status. In addition, according to an embodiment, identifier information of the relay UE 20 may be also included in the QoS flow notify item.

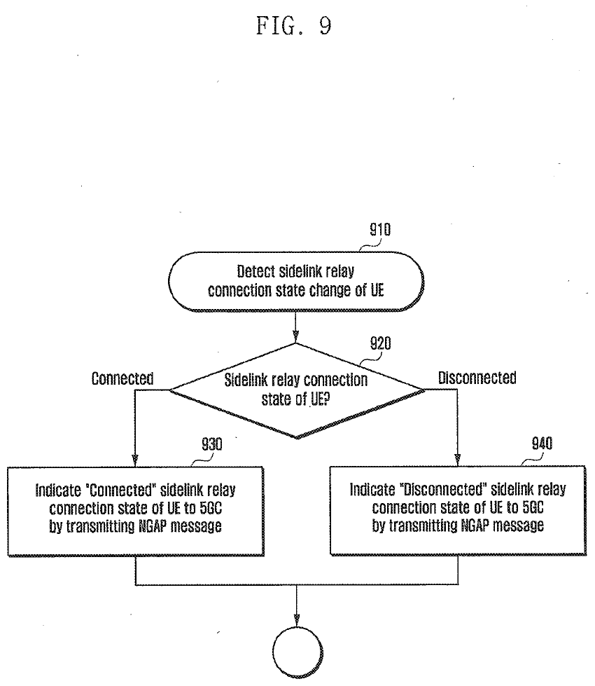

FIG. 9 illustrates a procedure of a base station for receiving, from a UPF, whether a remote user equipment (UE) receives a mobile communication service in a sidelink relay scheme and generating or suspending data usage information provided through a sidelink relay according to an embodiment of the disclosure. The embodiment of FIG. 9 is a flow chart illustrating a base station operation for transferring sidelink relay connection state information of a remote user equipment in a base station according to the embodiments of FIGS. 3A, 3B, 4, 6A, 6B, and 7.

Referring to FIG. 9, when detecting, in operation 910, a change in an operation (state or status) in which the remote UE is connected through a sidelink relay through the relay UE, the base station may determine, in operation 920, whether the remote UE is configured to be connected through the sidelink relay through the relay UE. In addition, as a result of the determination in operation 920, when the remote UE is configured to be connected through the sidelink relay through the relay UE, the base station may transmit, to the 5GC, an NGAP message including information notifying that the remote UE is configured to be connected through the sidelink relay in operation 930. This message may include identifier information of the relay UE together. When it is determined in operation 920 that there is a change from a sidelink relay connection of the remote UE through the relay UE to a radio interface (e.g., a Uu interface) connection with the base station, the base station may transmit, to the 5GC, an NGAP message including information notifying that the connection of the remote UE through the sidelink relay is disconnected, in operation 940. According to an embodiment, the 5GC may be the AMF.

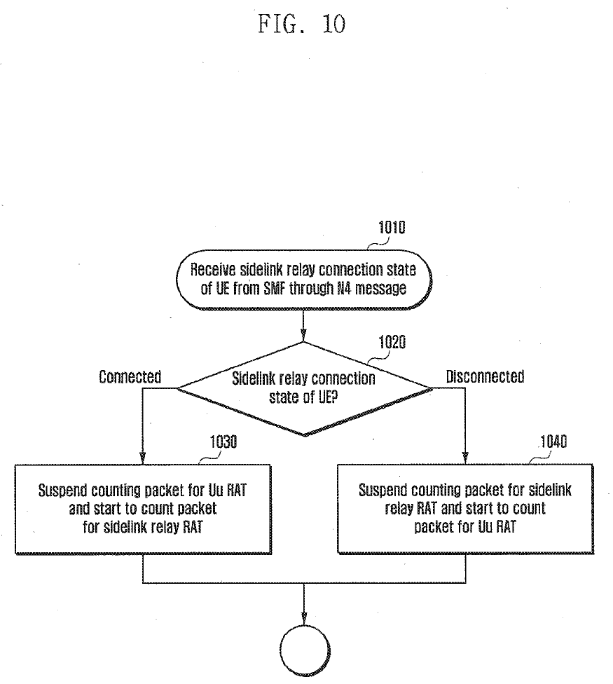

FIG. 10 illustrates a UPF procedure in which a UPF receives whether a remote user equipment receives a mobile communication service in a sidelink relay scheme so that the UPF can generate or suspend data usage information provided using a sidelink relay according to an embodiment of the disclosure. The embodiment of FIG. 10 shows a flow chart illustrating an operation of generating or suspending data usage information provided using a sidelink relay of the remote UE by the UPF according to the embodiments of FIGS. 3A, 3B, 4, 6A, 6B, and 7.

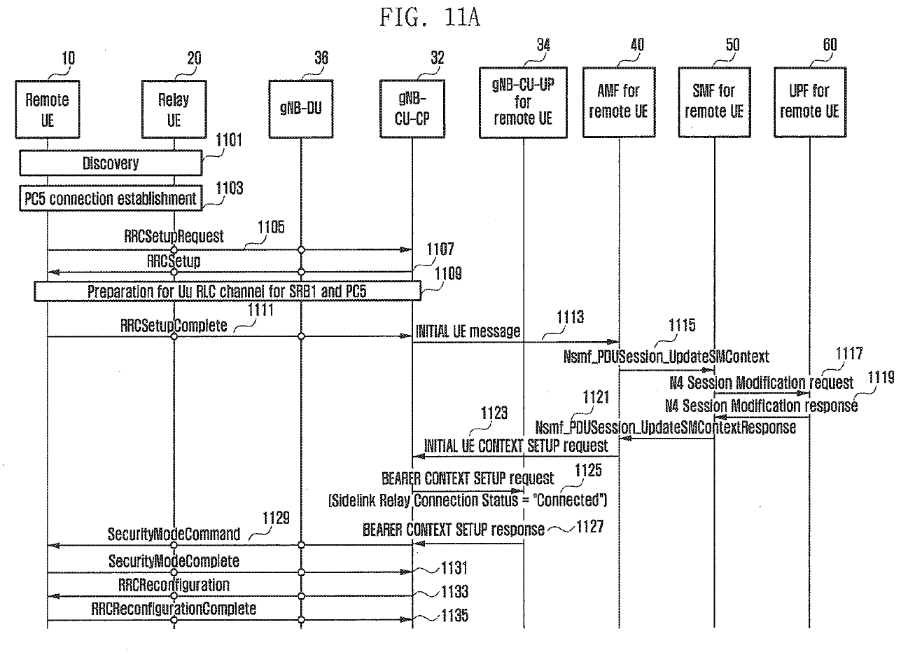

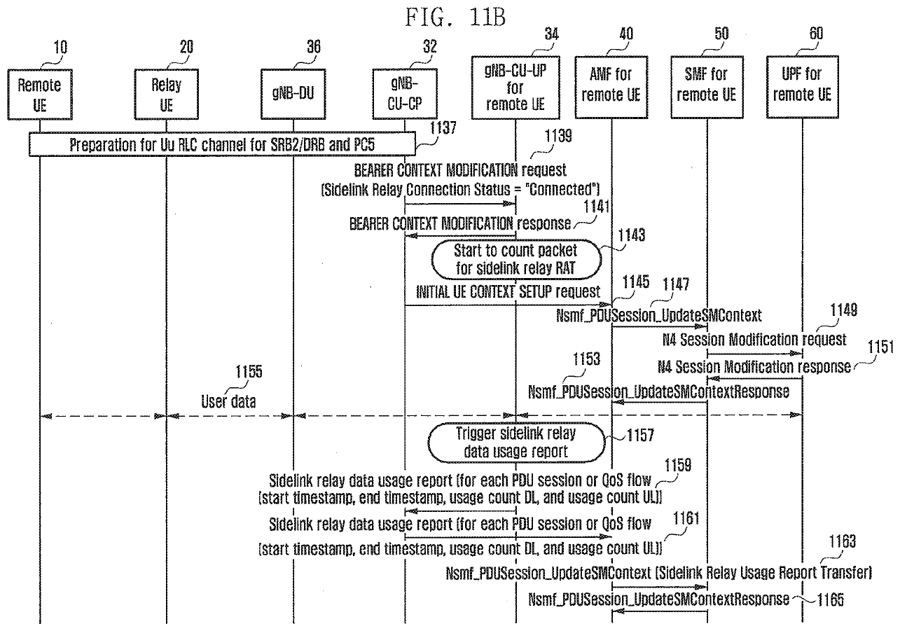

Referring to FIG. 10, when the UPF receives information indicating a change in a connection operation of the remote UE through a sidelink relay from the SMF by using an N4 message in operation 1010, the UPF may determine whether the remote UE is configured to be connected through the sidelink relay through the relay UE in operation 1020. In addition, as a result of the determination in operation 1020, when the remote UE is configured to be connected through the sidelink relay through the relay UE, the UPF suspends counting the user data packet service of the remote UE 10 as data used for a radio interface (e.g., a Uu interface) with a normal UE and a base station, and starts to count the user data packet service of the remote UE 10 as data usage by means of a sidelink relay, in operation 1030. When it is determined in operation 1020 that there is a change from a sidelink relay connection of the remote UE through the relay UE to a radio interface (e.g., a Uu interface) connection with the base station, the UPF suspends counting the user data packet service of the remote UE 10 as data usage by means of the sidelink relay, and starts to count the user data packet service of the remote UE 10 as data used for the radio interface (e.g., the Uu interface) with a normal UE and the base station, in operation 1040. FIGS. 11A and 11B illustrate signal flow charts illustrating a procedure in which a central unit-user plane (CU-UP) 34 of a base station 30 receives whether a remote user equipment (UE) 10 receives a mobile communication service in a sidelink relay scheme so that the CU-UP 34 can generate and transfer data usage information provided through a sidelink relay in a process in which the remote UE 10 performs a connection procedure with the base station 30 through a relay support UE (relay UE) 20 in a separated base station structure according to an embodiment of the disclosure. In FIGS. 11A and 11B, one or more SMFs 50 and one or more UPFs 60 for providing a mobile communication service of the remote UE 10 may be used, but the signal flow charts show only a case where one SMF 50 and one UPF 60 are used, and for a signal procedure from an AMF 40, the same signal procedure may be used also in a case where several SMFs and UPFs are used.

Referring to FIGS. 11A and 11B, in operations 1101 and 1103, for direct communication with a relay support UE (relay UE) 20, a remote user equipment (UE) 10 may perform a PC5 connection establishment procedure and a discovery procedure for a PC5 link connection. In operation 1103, a configuration for allowing the remote UE 10 to communicate with a base station 30 in a mobile communication network through the relay UE 20 may be included.

In operation 1105, the remote UE 10 may transfer, to the relay UE 20 by using a PC5 link, an RRC connection request message (e.g., an RRCSetupRequest message) to be transmitted to the base station 30, and the relay UE 20 may transmit the RRC connection request message (e.g., the RRCSetupRequest message) to the base station 30. In addition, the RRC connection request message (e.g., the RRCSetupRequest message) is transferred to the CU-CP 32 through a DU 36 of the base station 30. When the CU-CP 32 receives the RRC connection request message of the remote UE 10 through the relay UE 20, the CU-CP 32 may generate an RRC connection configuration message (e.g., an RRCSetup message) for the remote UE 10 and transmit the RRC connection configuration message (e.g., the RRCSetup message) to the remote UE 10 through the DU 36 and the relay UE 20 in operation 1107. In addition, in operation 1109, the remote UE 10, the relay UE 20, and the base stations 30, 32, 34, and 36 may perform a signal transmission and reception procedure and an operation for configuring a Uu RLC channel for signaling radio bearer 1 (SRB1) and a PC5 connection. The operation is the well-known technology and a detailed procedure is omitted. In operation 1111, the remote UE 10 may transmit an RRC connection configuration completion message (e.g., an RRCSetupComplete message) to the base station 30 through the relay support UE 20. The CU-CP 32 having received the RRC connection configuration completion message (e.g., the RRCSetupComplete message) from the remote UE 10 through the DU 36 of the base station 30 may transmit, in operation 1113, an initial UE message to the AMF 40 that is selected and operated for servicing the remote UE 10 of the 5GC, and may perform, up to operation 1147, a sidelink relay connection mode configuration procedure through the relay UE 20 for the provision of the mobile communication service of the remote UE 10. The AMF 40 having received the initial UE message from the CU-CP 32 of the base station 30 in operation 1113 may identify the SMF 50 for a protocol data unit (PDU) session connection for the service of the remote UE 10, and then may transmit Nsmf_PDUSession_UpdateSMContext to the corresponding SMF 50 in operation 1115. In addition, in operation 1117, the SMF 50 may identify again the UPF 60 for the corresponding PDU session service, and then transmit an N4 session modification request. In operation 1119, the UPF 60 may respond to the SMF 50 with an N4 session modification response, and the SMF 50 having received the same may transmit Nsmf_PDUSession_UpdateSMContextResponse to the AMF 40 in operation 1121. The AMF 40 may receive the message from all SMFs for the service of the remote UE 10 in operation 1121, and then may transmit an initial UE context setup request message to the CU-CP 32 of the base station 30 in operation 1123 to request configuration of context and a radio resource for the remote UE 10 from the base station 30. The CU-CP 32 of the base station 30 having received the initial UE context setup request message from the AMF 40 may transmit a bearer context setup request message to the CU-UP 34 in operation 1125. The bearer context setup request message may include information (e.g., configuring a Sidelink Relay Connection Status IE to be “Connected”) notifying that the remote UE 10 is in a sidelink relay connected state. In operation 1127, the CU-UP 34 may respond by transmitting a bearer context setup response message to the CU-CP 32.

In operations 1129 and 1131, the CU-CP 32 may exchange, with the remote UE 10 through the relay UE 20, an RRC SecurityModeCommand message and an RRC SecurityModeComplete message for a radio period encryption configuration. In addition, in operations 1133 and 1135, the CU-CP 32 may transmit an RRC reconfiguration message (e.g., an RRCReconfiguration message) to the remote UE 10 through the DU 36 and the relay UE 20, and may receive an RRC reconfiguration completion message (e.g., an RRCReconfigurationComplete message) from the remote UE 10 (through the relay UE 20 and the DU 36). In operation 1137, the remote UE 10, the relay UE 20, and the base station 30 may perform a signal transmission and reception procedure and an operation for configuring a Uu RLC channel for one or more data radio bearers (DRBs) and signaling radio bearer 2 (SRB2) and a PCS connection. The operation corresponds to the well-known technology, and thus a detailed procedure is omitted. After the completion of the configuration, in operation 1139, the CU-CP 32 may transmit a bearer context modification request message to the CU-UP 34. The bearer context modification request message may include information (e.g., configuring a Sidelink Relay Connection Status IE to be “Connected”) notifying that the remote UE is in a sidelink relay connected state. In operation 1141, the CU-UP 34 may respond by transmitting a bearer context modification response message to the CU-CP 32.

According to the information (e.g., configuring a Sidelink Relay Connection Status IE to be “Connected”) notifying that the remote UE 10 is in the sidelink relay connected state, the information being included in the message transmitted by the CU-CP 32 in operation 1125 or 1139, the CU-UP 34 starts to count a user data packet service of the remote UE 10 as data usage by means of a sidelink relay in operation 1143.

According to an embodiment, the information (e.g., configuring a Sidelink Relay Connection Status IE to be “Connected”) notifying that the remote UE 10 is in the sidelink relay connected state, the information being included in the message and transmitted in operation 1125 may indicate an initial connection station of the remote UE 10. In addition, the information (e.g., configuring a Sidelink Relay Connection Status IE to be “Connected”) notifying that the remote UE 10 is in the sidelink relay connected state, the information being included in the message transmitted in operation 1139 may indicate changed state information when the connection state of the remote UE 10 is changed during the connection configuration process (e.g., the state is changed from a state in which a sidelink relay connection is not established to a state in which the sidelink relay connection is established). According to an embodiment, when the connection state of the remote UE 10 is not changed, the message transmitted in operation 1139 may not include the connection state information of the remote UE 10.

According to an embodiment, the connection state information of the remote UE 10 may be included in either the message transmitted in operation 1125 or the message transmitted in operation 1139. For example, the message transmitted in operation 1125 may not include the connection state information of the remote UE 10, and the message transmitted in operation 1139 may include the connection state information of the remote UE 10.

In operation 1145, the CU-CP 32 may transmit an initial UE context setup response message to the AMF 40 to notify the AMF 40 of the contents of the configuration of the context and radio resource for the remote UE 10. The AMF 40 may transmit, in operation 1147, Nsmf_PDUSession_UpdateSMContext to the SMFs 50, and the SMF 50 may transmit, in operation 1149, an N4 session modification request to the UPF 60. The UPF 60 may respond, in operation 1151, to the SMF 50 with an N4 session modification response. In operation 1153, the SMF 50 may transmit Nsmf_PDUSession_UpdateSMContextResponse to the AMF 40. When operations up to operation 1153 have been performed, the connection procedure for the remote UE 10 has been completed, and a data packet associated with the remote UE 10 can be transmitted or received as in operation 1155.

Thereafter, when the CU-UP 34 needs to perform sidelink relay data usage reporting in operation 1157 according to information configured for the CU-UP 34 for sidelink relay data usage reporting (e.g., configuration of period information by OAM or implementation), the CU-UP 34 may transfer sidelink replay data usage information (e.g., by using a sidelink relay data usage report message) to the CU-CP 32 in operation 1159, and the CU-CP 32 may transfer the sidelink relay data usage information (e.g., by using the sidelink relay data usage report message) to the AMF 40 in operation 1161. According to an embodiment, in operation 1157, the CU-UP 34 may identify that the sidelink relay data usage reporting is to be performed when a period or a condition indicated by configuration information according to configuration information received from a core network entity is satisfied. Alternatively, according to an embodiment, when receiving an indication from another network entity to perform the sidelink relay data usage reporting, the CU-UP 34 may identify that the reporting is to be performed. The sidelink relay data usage information may include at least one of information (e.g., a start timestamp) associated with a start time point of performing data transmission or reception using the sidelink relay), information (e.g., an end timestamp) associated with an end time point, downlink usage information (e.g., usage count DL), and uplink usage information (e.g., usage count UL). According to an embodiment, the sidelink relay data usage information may be calculated for each PDU session and reported to the CU-CP 32 by the CU-UP 34. Alternatively, according to an embodiment, the sidelink relay data usage information may be calculated for each QoS flow and reported to the CU-CP 32 by the CU-UP 34. The AMF 40 may transfer, in operation 1163, the sidelink relay data usage information received from the base station 30 to the SMF 50 handling the corresponding PDU session by including the information in the Nsmf_PDUSession_UpdateSMContext message. In operation 1165, the SMF 50 may respond by transmitting an Nsmf_PDUSession_UpdateSMContextResponse message to the AMF 40.

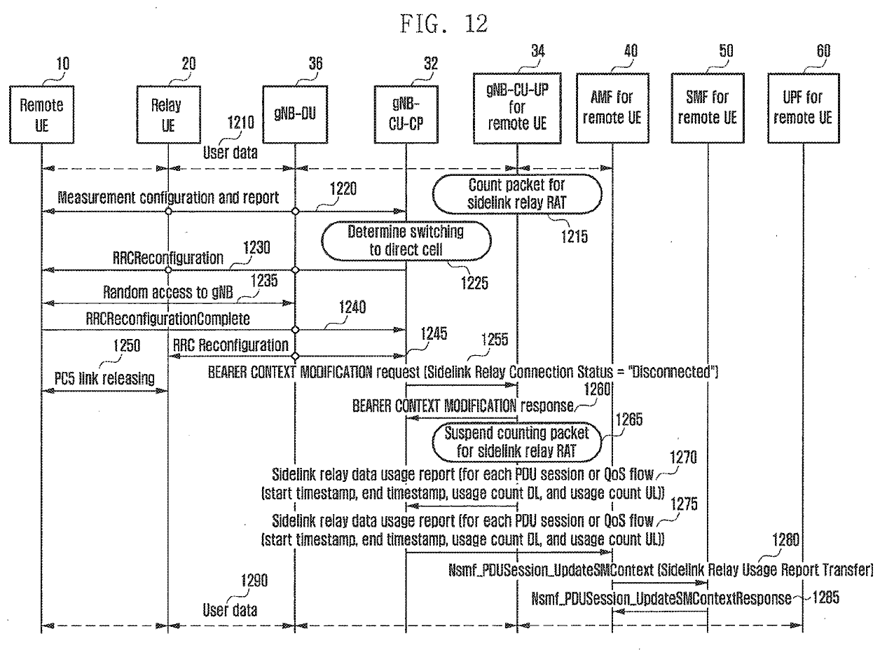

FIG. 12 is a signal flow chart illustrating a procedure in which a central unit-user plane (CU-UP) 34 of a base station 30 receives whether a remote user equipment (UE) 10 receives a mobile communication service in a sidelink relay scheme so that the CU-UP 34 can suspend generation of data usage information provided through a sidelink relay in a process in which the remote UE 10 performs a procedure of performing path switch to a radio interface (e.g., a Uu interface) connection with the base station 30 from the state in which the remote UE 10 is connected to the base station 30 through a relay support UE (relay UE) 120. In FIG. 12, one or more SMFs 50 and one or more UPFs 60 for providing a mobile communication service of the remote UE 10 may be used, but the signal flow chart shows only a case where one SMF 50 and one UPF 60 are used, and for a signal procedure from an AMF 40, the same signal procedure may be used also in a case where several SMFs and UPFs are used. In addition, FIG. 12 illustrates a procedure of a case where the remote UE 10 and the relay UE 20 are connected to the same base station 30, but the procedure of FIG. 12 can be used also in a case where the remote UE 10 and the relay UE 20 are connected to different base stations from each other, and only an additional procedure for handover between the base stations may be added and operated.

Referring to FIG. 12, in the state in which the remote UE 10 is connected to the base station 30 through the relay UE 20 and receives a mobile communication service, the remote UE 10 may perform transmission of reception of a data packet of the remote UE 10 through the relay UE 20 as in operation 1210. The CU-UP 34 of the base station 30 may count a user data packet service of the remote UE 10 as data usage by means of a sidelink relay in operation 1215.

In operation 1220, after measuring a signal according to a measurement configuration for relay support candidate UEs and a neighboring base station configured by the base station 30, the remote UE 10 reports a result of the measurement to the CU-CP 32 of the base station 30 through the relay UE 20 and a DU 36 of the base station 30. The CU-CP 32 having received measurement report information from the remote UE 10 may determine to change to a radio interface (e.g., a Uu interface) connection of the remote UE 10 with the base station 30 in operation 1225, and may perform an indirect-to-direct path switch procedure for changing a connection path of the remote UE 10 in operation 1230 to operation 1250. When determining the path switch in operation 1225, the CU-CP 32 may transmit, in operation 1230, an RRC reconfiguration message (e.g., an RRCReconfiguration message) to the remote UE 10 through the DU 36 and the relay UE 20 for the change of the connection path of the remote UE 10. The remote UE 10 having received the RRC reconfiguration message (e.g., the RRCReconfiguration message) may perform, based on the RRC reconfiguration message (e.g., the RRCReconfiguration message), a random access procedure to the base station 30 in operation 1235, and when the random access is completed, may transmit an RRC reconfiguration completion message (e.g., an RRCReconfigurationComplete message) to the CU-CP 32 through the DU 36 in operation 1240. The CU-CP 32 having received the reconfiguration completion message (e.g., the RRCReconfigurationComplete message) from the remote UE 10 may perform an RRC connection reconfiguration procedure with the relay UE 20 through the DU 32 in operation 1245 to release sidelink relay transmission of the remote UE 10, and may perform a connection release procedure for a PC5 link with the remote UE 10 in operation 1250.

When the remote UE 10 identifies, in operation 1240, that the connection procedure to the radio interface (e.g., the Uu interface) with the base station 30 has been completed, the CU-CP 32 may transmit a bearer context modification request message to the CU-UP 34 in operation 1255, and the message may include information (e.g., configuring a Sidelink Relay Connection Status IE to be “Disconnected”) notifying that the remote UE 10 is in a sidelink relay connection released state. In operation 1260, the CU-UP 34 may respond by transmitting a bearer context modification response message to the CU-CP 32.

After the CU-UP 34 receives the information (e.g., configuring the Sidelink Relay Connection Status IE to be “Disconnected”) notifying that the remote UE 10 is in a sidelink relay connection released state in operation 1255, the CU-UP 34 may suspend counting the user data packet service of the remote 10 as data usage by means of a sidelink relay in operation 1265. The CU-UP 34 may transfer sidelink replay data usage information (e.g., by using a sidelink relay data usage report message) as data usage information of the remote UE 10 to the CU-CP 32 in operation 1270. In addition, the CU-CP 32 may transfer the sidelink relay data usage information (e.g., by using the sidelink relay data usage report message) to the AMF 40 in operation 1275. The AMF 40 may transmit, in operation 1280, the sidelink relay data usage information received from the base station 30 in operation 1275 to the SMF 50 handling the corresponding PDU session by including the information in the Nsmf_PDUSession_UpdateSMContext message. In operation 1285, the SMF 50 may respond by transmitting Nsmf_PDUSession_UpdateSMContextResponse to the AMF 40. The sidelink relay data usage information may include at least one of information (e.g., a start timestamp) associated with a start time point of performing data transmission or reception using the sidelink relay), information (e.g., an end timestamp) associated with an end time point, downlink usage information (e.g., usage count DL), and uplink usage information (e.g., usage count UL). In addition, the sidelink relay data usage information may be determined for each PDU session or for each QoS flow.

After the remote UE 10 completes the connection procedure through a radio interface (e.g., a Uu interface) with the base station 30 in operation 1240, the data packet of the remote UE 10 may be transferred by means of the radio interface (e.g., the Uu interface) with the UE 10 and the base station 30 as in operation 1290.

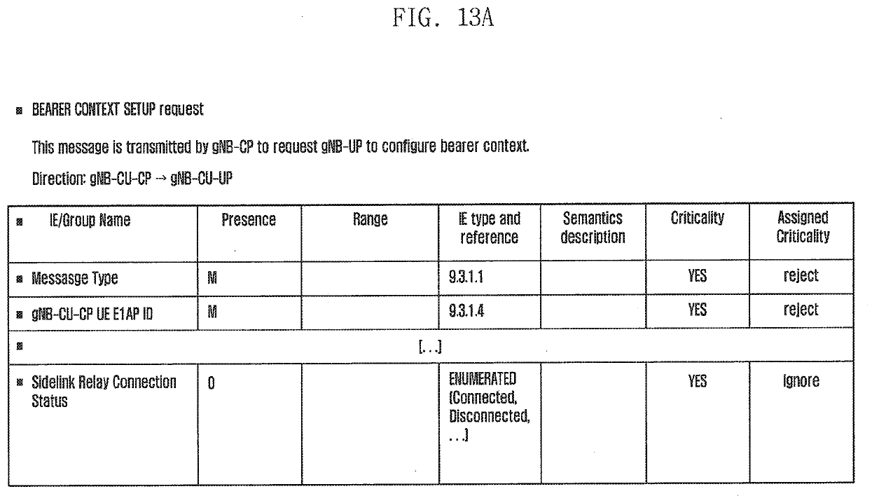

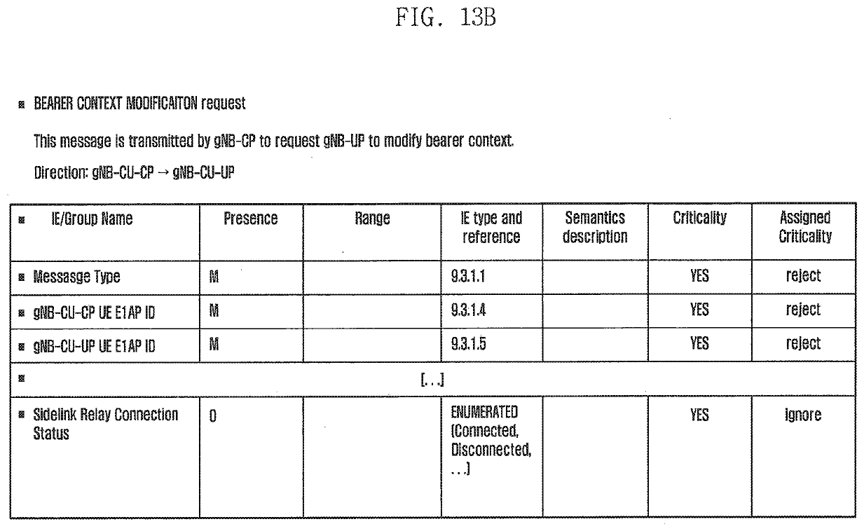

FIGS. 13A and 13B illustrate an example of a message for transmitting state information of a remote user equipment to a CU-UP of a base station by a CU-CP of the base station according to an embodiment of the disclosure.

Referring to FIGS. 13A and 13B, an example of a configuration of an El AP message (e.g., a bearer context setup request message and a bearer context modification request message) used to transfer sidelink relay connection state information of a remote user equipment (remote UE) to a CU-UP of a base station by a CU-CP of the base station, the message being used in operation 1125 or 1139 in FIGS. 11A and 11B and in operation 1255 in FIG. 12, is illustrated. The E1AP used to transfer the sidelink relay connection state information may include message type information for distinguishing a message type and an identifier for distinguishing a UE in UE-associated signaling, e.g., a gNB-CU-CP UE E1AP ID and an RgNB-CU-UP UE E1AP ID. In addition, sidelink relay connection status information for the disclosure may be included, for example, the sidelink relay connection status information may include “Connected” and “Disconnected” status information, and different terms may be used for the same. In addition, only one value between “Connected” and “Disconnected” may be included, and other additional information may be included. FIGS. 13A and 13B illustrate an example of an El AP message (e.g., a bearer context setup request message and a bearer context modification request message) used to transfer sidelink relay connection state information, but the sidelink relay connection state information of the remote UE, the information being included in FIGS. 11A and 11B, may be included in the other existing E1AP message or included in a newly defined E1AP message and transmitted from the CU-CP to the CU-UP.

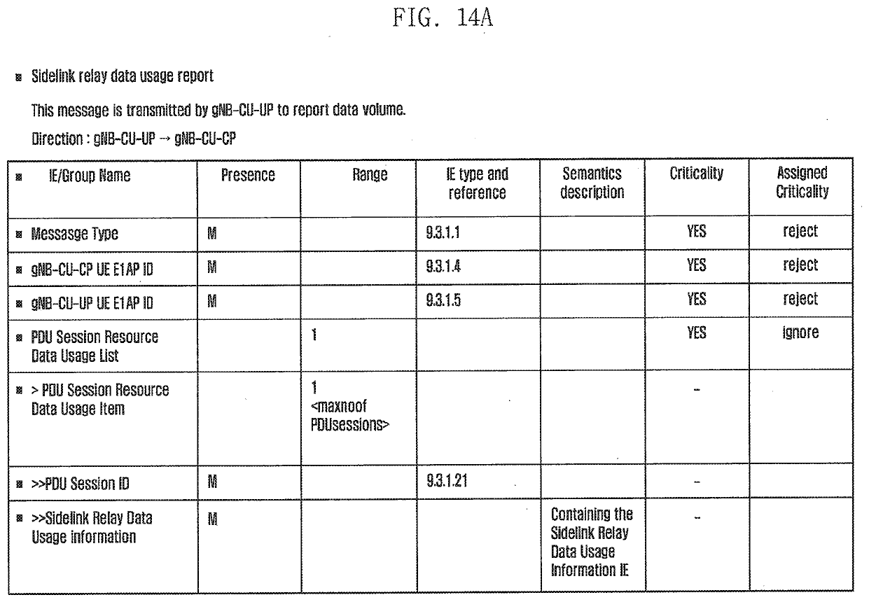

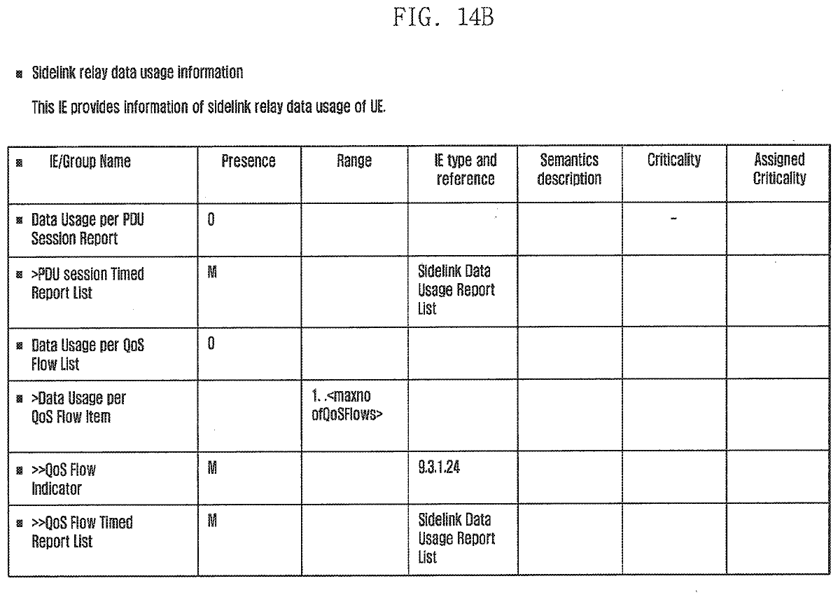

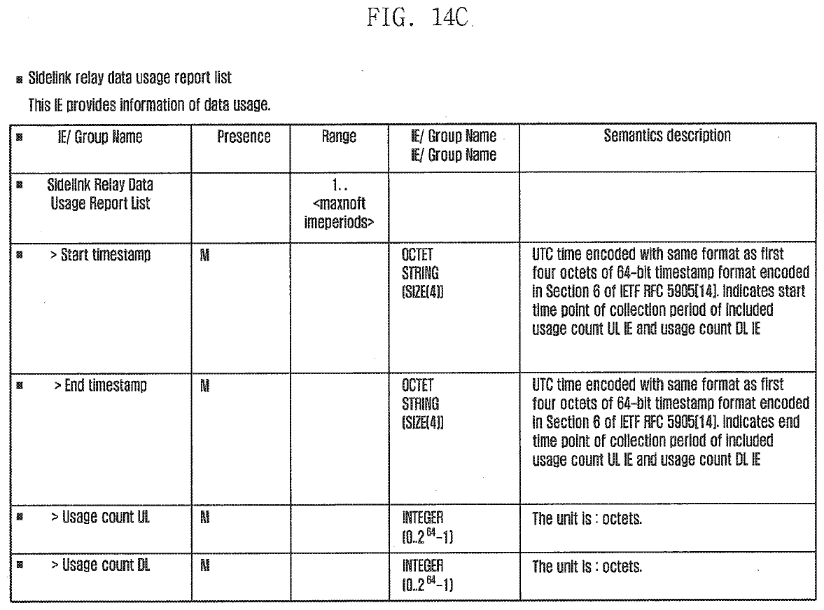

FIGS. 14A, 14B, and 14C illustrate an example of a message for transmitting state information of a remote user equipment to a CU-CP of a base station by a CU-UP of the base station according to an embodiment of the disclosure.

Referring to FIGS. 14A, 14B, and 14C, an example of a configuration of an E1AP message (e.g., a sidelink relay data usage report message) used to transfer sidelink relay data usage information of a remote UE to a CU-CP 32 of a base station by a CU-UP 34 of the base station, the message being used in operation 1159 of FIGS. 11A and 11B and operation 1270 in FIG. 12, is illustrated. The E1AP message used to transfer the sidelink relay data usage information may include message type information for distinguishing a message type and an identifier for distinguishing a UE in UE-associated signaling, e.g., a gNB-CU-CP UE E1AP ID and a gNB-CU-UP UE E1AP ID. In addition, sidelink relay data usage information (e.g., a Sidelink Relay Data Usage Information IE for each PDU session) of the remote UE for the disclosure may be included. The sidelink relay data usage information (e.g., Sidelink Relay Data Usage Information IE) may include a data usage time (e.g., a start timestamp and an end timestamp) by means of a sidelink relay for each PDU session and data usage information (e.g., usage count UL and usage count DL), Only the data usage time, only the data usage information, or both the data usage time and the data usage information may be included.

According to an embodiment, the sidelink relay data usage information of the remote UE may be determined for each QoS flow. For example, the sidelink relay data usage information of the remote UE may include a Sidelink Relay Data Usage Information IE for each QoS flow. To this end, information identifying the corresponding QoS flow (QoS flow indicator) may be included in the Sidelink Relay Data Usage Information IE. The sidelink relay data usage information (e.g., the Sidelink Relay Data Usage Information IE) may include data usage time (e.g., a start timestamp and an end timestamp) by means of a sidelink relay for each QoS flow and data usage information (e.g., usage count UL and usage count DL).

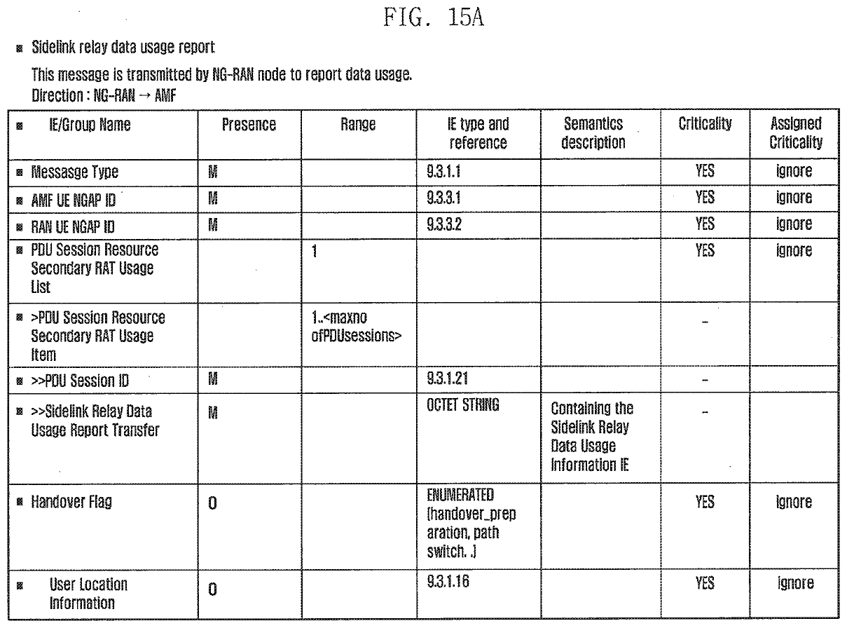

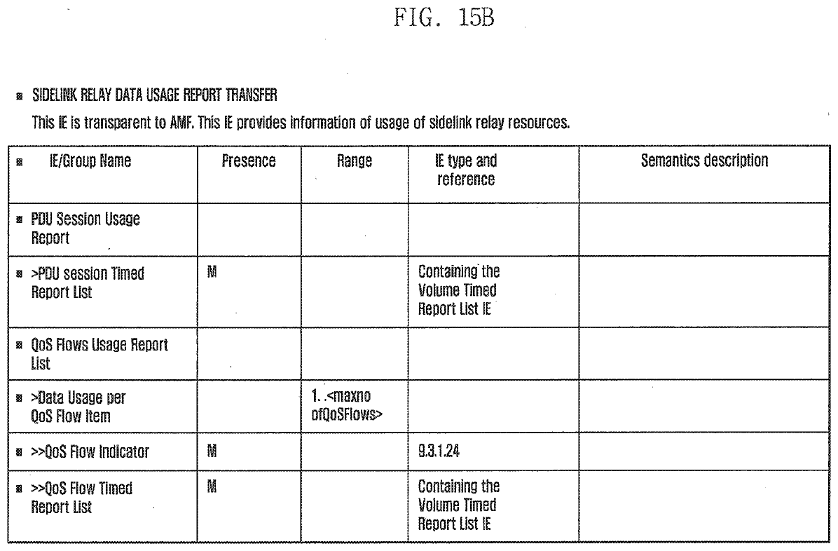

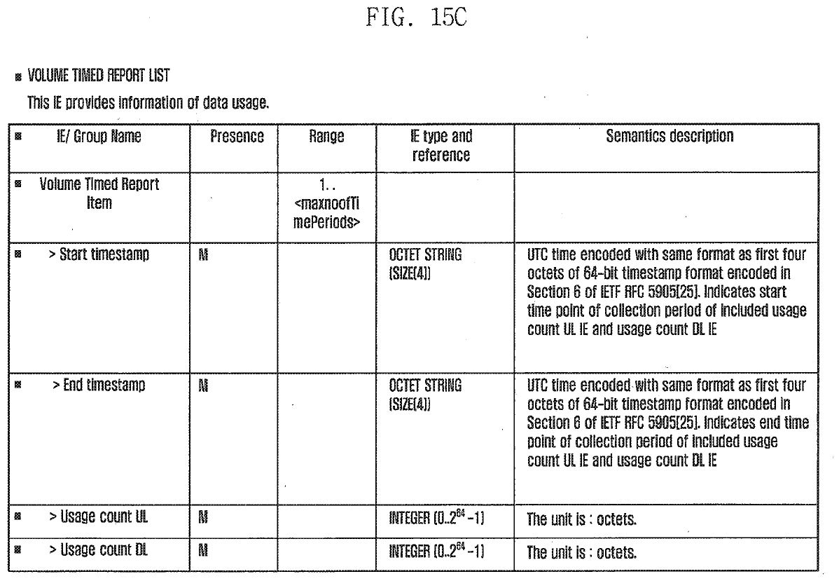

FIGS. 15A, 15B, and 15C illustrate an example of a message for transmitting state information of a remote user equipment to an AMF by a CU-CP of a base station according to an embodiment of the disclosure.

Referring to FIGS. 15A, 15B, and 15C, an example of an NGAP message (e.g., a sidelink relay data usage report message) used to transfer sidelink relay data usage information of a remote user equipment (remote UE) to an AMF 40 of a 5GC by a CU-CP 32 of a base station, the message being used in operation 1161 in FIGS. 11A and 11B and operation 1275 in operation 12, is illustrated. The NGAP message used to transfer the sidelink relay data usage information may include message type information for distinguishing a message type and an identifier for distinguishing a UE in UE-associated signaling, e.g., an AMF UE NGAP ID and a RAN UE NGAP ID. In addition, the sidelink relay data usage information (e.g., a Sidelink Relay Data Usage Report Transfer IE for each PDU session) of the remote UE for the disclosure may be included, and other information may be also included. The sidelink relay data usage information (e.g., the Sidelink Relay Data Usage Report Transfer IE) may include a data usage time (e.g., a start timestamp and an end timestamp) by means of a sidelink relay for each PDU session and data usage information (e.g., usage count UL and usage count DL). and only the data usage time, only the data usage information, or both the data usage time and the data usage information may be included. The AMF 40 transfers the sidelink relay data usage information (e.g., the Sidelink Relay Data Usage Report Transfer IE) to the SMF 50, According to an embodiment, the sidelink relay data usage information of the remote UE may be determined for each QoS flow. For example, the sidelink relay data usage information of the remote UE may include a Sidelink Relay Data Usage Report Transfer IE for each QoS flow. To this end, information identifying the corresponding QoS flow (e.g., a QoS flow indicator) may be included in the Sidelink Relay Data Usage Report Transfer IE. The sidelink relay data usage information (e.g., the Sidelink Relay Data Usage Report Transfer IE) may include a data usage time (e.g., a start timestamp and an end timestamp) by means of a sidelink relay for each QoS flow and data usage information (e.g., usage count UL and usage count DL).

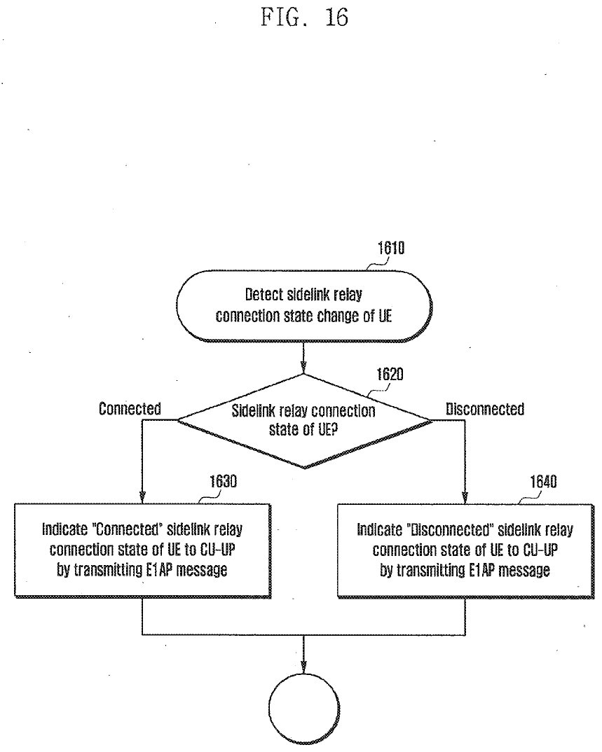

FIG. 16 illustrates a procedure of a CU-CP of base station, in which the CU-UP of the base station receives whether a remote user equipment (UE) receives a mobile communication service in a sidelink relay scheme so that the CU-UP of the base station can generate or suspend data usage information provided through a sidelink relay according to an embodiment of the disclosure. The embodiment of FIG. 16 is a flow chart illustrating a base station operation for transferring sidelink relay connection state information of a remote user equipment (remote UE) to a CU-UP of a base station by a CU-CP of the base station according to embodiments of FIGS. 11A, 11B, and 12.

Referring to FIG. 16, when detecting a change in a connection operation of a remote user equipment (remote UE) through a sidelink relay through a relay support UE (relay UE) in operation 1610, a CU-CP of a base station may determine whether the remote UE is configured to be connected through the sidelink relay through the relay UE in operation 1620. In addition, as a result of the determination in operation 1620, when the remote UE is configured to be connected through the sidelink relay through the relay UE, the CU-CP of the base station may transmit, to the CU-UP, an E1AP message including information notifying that the remote UE is configured to be connected through the sidelink relay in operation 1630. When it is determined in operation 1620 that there is a change from a sidelink relay connection of the remote UE through the relay UE to a radio interface (e.g., a Uu interface) connection with the base station, the CU-CP of the base station may transmit, to the CU-UP, an E1AP message including information notifying that the connection of the remote UE through the sidelink relay is disconnected, in operation 1640.

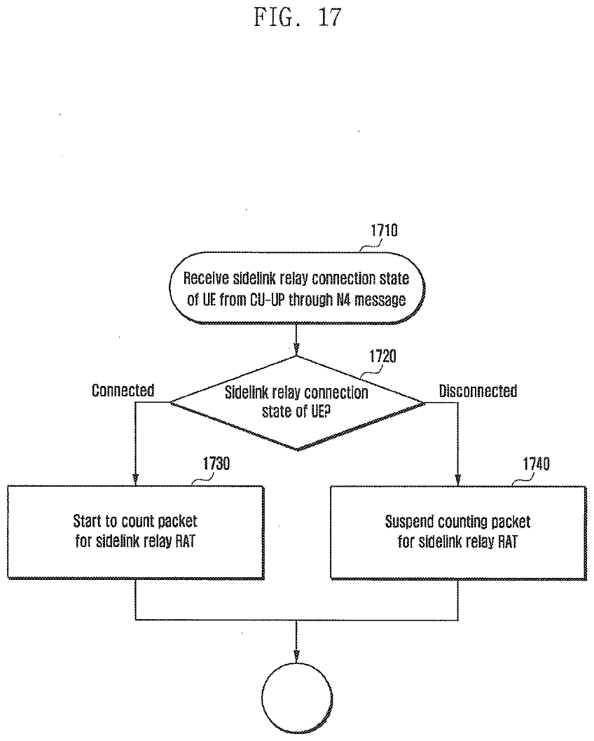

FIG. 17 illustrates a procedure of a CU-UP of a base station, in which a CU-UP of a base station receives whether a remote user equipment (remote UE) receives a mobile communication service in a sidelink relay scheme so that the CU-UP of the base station can generate or suspend data usage information provided through a sidelink relay according to an embodiment of the disclosure. The embodiment of FIG. 17 is a flow chart illustrating an operation for generating or suspending, by a CU-CP of the base station, data usage information provided through a sidelink relay according to sidelink relay connection state information of a remote user equipment (remote UE), received from a CU-CP according to embodiments of FIGS. 11A, 11B, and 12.

Referring to FIG. 17, when the CU-UP of the base station receives information indicating a change in a connection operation of the remote UE from the CU-CP through a sidelink relay through a relay support UE (relay UE) in operation 1710, the CU-CP may determine whether the remote UE is configured to be connected through the sidelink relay through the relay UE in operation 1720. In addition, as a result of the determination in operation 1720, when the remote UE is configured to be connected through the sidelink relay through the relay UE, the CU-UP starts to count the user data packet service of the remote UE 10 as data usage by means of a sidelink relay, in operation 1730. When it is determined in operation 1720 that there is a change from a sidelink relay connection of the remote UE through the relay UE to a radio interface (e.g., a Uu interface) connection with the base station, the CU-UP suspends counting the user data packet service of the remote UE 10 as data usage by means of the sidelink relay, in operation 1740.

In addition, an embodiment of the disclosure provides a method in which a base station transfers, to a core network, whether a UE is directly connected to a mobile communication base station or is connected to the mobile communication base station through a sidelink relay, so as to change a connection policy, e.g., a QoS parameter configuration.

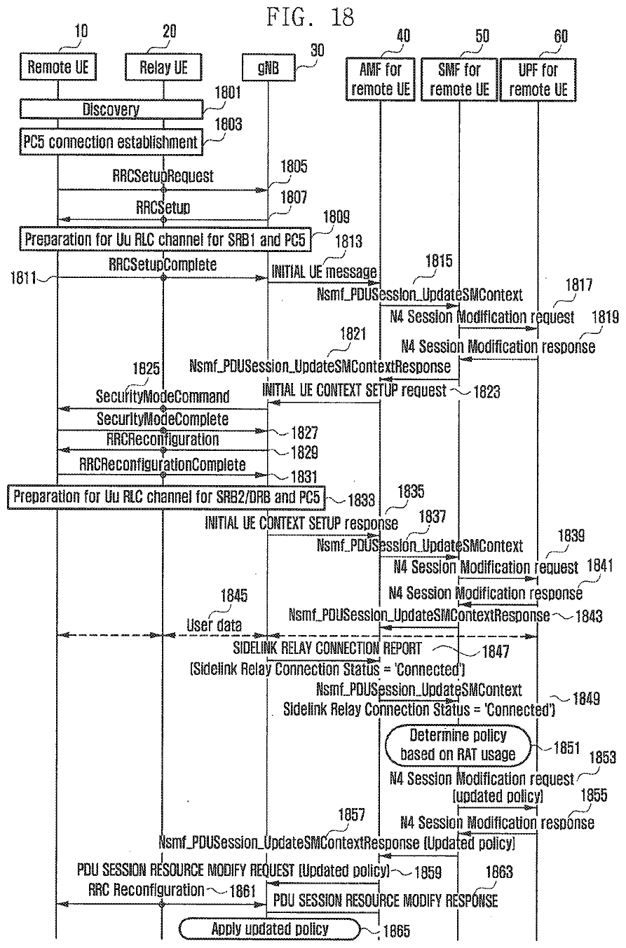

FIG. 18 is a signal flow chart illustrating a procedure in which a 5GC receives whether a remote user equipment (remote UE) 10 receives a mobile communication service in a sidelink relay scheme, so as to change a connection policy (e.g., a QOS parameter configuration) in a process in which the remote UE 10 performs a connection procedure with a base station 30 through a relay support UE (relay UE) 20 according to an embodiment of the disclosure. In FIG. 18, one or more SMFs 50 and one or more UPFs 60 for providing a mobile communication service of the remote UE 10 may be used, but the signal flow chart shows only a case where one SMF 50 and one UPF 60 are used, for a signal procedure from an AMF 40, the same signal procedure may be used also in a case where several SMFs and UPFs are used, and other 5GC functions (e.g., PCF), and the like which can be related in determining the connection policy may follow the existing procedure and are not thus included.

Referring to FIG. 18, operations 1801 to 1845 are identical to the procedures from operations 301 to 345 in FIGS. 3A and 3B, the description with reference to FIGS. 3A and 3B is applied, and thus a separate description is omitted. The base station 30 may identify that the remote UE 10 is connected through the relay UE 20. In addition, in this case, the base station 30 may transmit a sidelink relay connection report message to the AMF 40 in operation 1847. The sidelink relay connection report message may include information (e.g., configuring a Sidelink Relay Connection Status IE to be “Connected”) notifying that the remote UE 10 is in a sidelink relay connected state. The AMF 40 having received the same may transmit Nsmf_PDUSession_UpdateSMContext to the SMF 50 in operation 1849, and the Nsmf_PDUSession_UpdateSMContext message may include information (e.g., configuring a sidelink relay connection status to be “Connected”) notifying the sidelink relay connected state. The SMF 50 having received this information may reconfigure a policy (e.g., a QoS parameter configuration for each QoS flow) for servicing the remote UE according to the sidelink relay connection state information of the remote UE 10 in operation 1851. The SMF 50 may transmit an N4 session modification request to the UPF 60 in operation 1853, and the UPF 60 may respond to the SMF 50 with an N4 session modification response in operation 1855. The SMF 50 may transmit the policy (e.g., the QoS parameter configuration for each QoS flow) determined and changed in operation 1851 to the AMF 40 in operation 1857, and the AMF 40 may transfer the changed policy (e.g., the QoS parameter configuration for each QoS flow) to the base station 30 in operation 1859. In addition, the base station 30 may perform an RRC connection reconfiguration procedure of the remote UE 10 to reconfigure the changed policy (e.g., the QoS parameter configuration for each QoS flow) in operation 1861. If necessary, an RRC connection reconfiguration procedure for relay-related reconfiguration for the relay UE 20 to support the remote UE 10 may be additionally performed, and this procedure is omitted from FIG. 18. In operation 1863, the base station 30 may transmit a response message notifying that the policy has been applied to the AMF 40. After receiving the changed policy (e.g., the QOS parameter configuration for each QOS flow) in operation 1859, the base station 30 may apply the changed policy (e.g., the QoS parameter configuration for each QoS flow) in operation 1965.

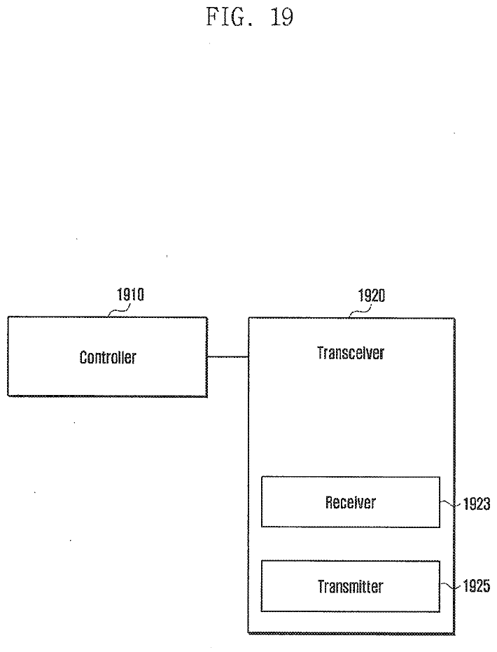

FIG. 19 illustrates a configuration of a UE according to an embodiment of the disclosure.

Referring to FIG. 19, a UE according to an embodiment of the disclosure may include a transceiver 1920 and a controller 1910 for controlling the overall operation of the UE. In addition, the transceiver 1920 may include a transmitter 1925 and a receiver 1923. In addition, the UE may include one of a remote user equipment (remote UE) and a remote user equipment (remote UE).

The transceiver 1920 may transmit or receive a signal to or from other network entities.

The controller 1910 may control the UE to perform one operation among the above-described embodiments. The controller 1910 and the transceiver 1920 are not necessarily implemented as separate modules, and may be implemented by one element in the form such as a single chip. In addition, the controller 1910 and the transceiver 1920 may be electrically connected. For example, the controller 1910 may be a circuit, an application-specific circuit, or at least one processor. In addition, the operations of the UE may be implemented by including, in an arbitrary element in the UE, a memory device having a corresponding program code stored therein.

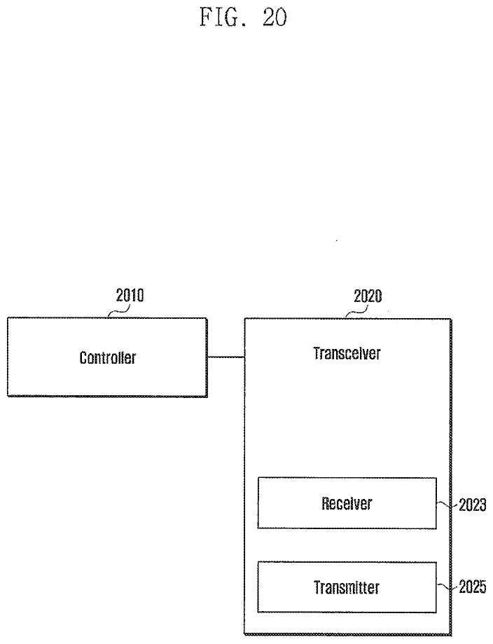

FIG. 20 illustrates a configuration of a network entity according to an embodiment of the disclosure.

Referring to FIG. 20, a network entity according to an embodiment of the disclosure may include a transceiver 2020 and a controller 2010 for controlling the overall operation of the network entity. In addition, the transceiver 2020 may include a transmitter 2025 and a receiver 2023.

The transceiver 2020 may transmit or receive a signal to or from other network entities.

The controller 2010 may control the network entity to perform one operation among the above-described embodiments. The controller 2010 and the transceiver 2020 are not necessarily implemented as separate modules, and may be implemented by one element in the form such as a single chip. In addition, the controller 2010 and the transceiver 2020 may be electrically connected. For example, the controller 610 may be a circuit, an application-specific circuit, or at least one processor. In addition, the operations of the network entity may be implemented by including, in an arbitrary element in the network entity, a memory device having a corresponding program code stored therein.

The network entity may mean a base station, a CU-CP of the base station, a CU-UP of the base station, and one of a DU, AMF, SMF, UPF, PCF, AF, NEF, UDM, UDR, NF, and AUSF of the base station.

It should be noted that the configuration diagrams, illustrative diagrams of control/data signal transmission methods, illustrative diagrams of operation procedures, and structural diagrams as illustrated in FIG. 1 to FIG. 20 are not intended to limit the scope of protection of the disclosure. That is, all the constituent units, entities, or operation steps shown in FIG. 1 to FIG. 20 should not be construed as essential elements for implementing the disclosure, and even when including only some of the elements, the disclosure may be implemented without impairing the true nature of the disclosure.

The above-described operations of a base station or a terminal may be implemented by providing a memory device storing corresponding program codes in a bast station or terminal device. That is, a controller of the base station or terminal device may perform the above-described operations by reading and executing the program codes stored in the memory device by means of a processor or central processing unit (CPU).

Various units or modules of a network entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a central unit-control plane (CU-CP) of a base station in a wireless communication system, the method comprising:
transmitting, to a central unit-user plane (CU-UP) of the base station, a first message comprising information indicating whether a remote user equipment (UE) is in a state of being connected through a sidelink relay;
in case that a preconfigured condition is satisfied, receiving, from the CU-UP, a second message comprising information on data usage by means of the sidelink relay of the remote UE; and
transmitting, to an access and mobility management function (AMF), a third message comprising information on the data usage by means of the sidelink relay of the remote UE.

2. The method of claim 1, further comprising:
in case that a connection state of the remote UE is changed from a connection through the sidelink relay to a radio interface connection with the base station, transmitting, to the CU-UP, a fourth message comprising information indicating a state in which the connection through the sidelink relay is released;
receiving, from the CU-UP, a fifth message comprising information on data usage by means of the sidelink relay of the remote UE until the connection through the sidelink relay is released; and
transmitting, to the AMF, a sixth message comprising information on the data usage by means of the sidelink relay of the remote UE.

3. The method of claim 1, wherein the first message comprises at least one of a bearer context setup request message or a bearer context modification request message.

4. The method of claim 1, wherein the information on the data usage by means of the sidelink relay of the remote UE is a value calculated for each protocol data unit (PDU) session or each quality of service (QOS) flow, and
wherein the information on the data usage by means of the sidelink relay of the remote UE comprises at least one of information associated with a start time point of performing data transmission or reception using the sidelink relay, information associated with an end time point of performing data transmission or reception using the sidelink relay, uplink data usage information, or downlink data usage information.

5. A method performed by a central unit-user plane (CU-UP) of a base station in a wireless communication system, the method comprising:
receiving, from a central unit-control plane (CU-CP) of the base station, a first message comprising information indicating whether a remote user equipment (UE) is in a state of being connected through a sidelink relay;
identifying, based on the information, information on data usage by means of the sidelink relay of the remote UE; and
in case that a preconfigured condition is satisfied, transmitting, to the CU-CP, a second message comprising information on the data usage by means of the sidelink relay of the remote UE.

6. The method of claim 5, further comprising:
in case that a connection state of the remote UE is changed from a connection through the sidelink relay to a radio interface connection with the base station, receiving, from the CU-CP, a fourth message comprising information indicating a state in which the connection through the sidelink relay is released;
suspending calculation of the data usage by means of the sidelink relay of the remote UE; and
transmitting, to the CU-CP, a fifth message comprising information on the data usage by means of the sidelink relay of the remote UE, the information being identified until a time point of the suspension of the calculation.

7. The method of claim 5, wherein the first message comprises at least one of a bearer context setup request message or a bearer context modification request message.

8. The method of claim 5, wherein the information on the data usage by means of the sidelink relay of the remote UE is a value calculated for each protocol data unit (PDU) session or each quality of service (QOS) flow, and
wherein the information on the data usage by means of the sidelink relay of the remote UE comprises at least one of information associated with a start time point of performing data transmission or reception using the sidelink relay, information associated with an end time point of performing data transmission or reception using the sidelink relay, uplink data usage information, or downlink data usage information.

9. A central unit-control plane (CU-CP) of a base station in a wireless communication system, the CU-CP comprising:
a transceiver; and
a controller connected to the transceiver and configured to:
transmit, to a central unit-user plane (CU-UP) of the base station, a first message comprising information indicating whether a remote user equipment (UE) is in a state of being connected through a sidelink relay;
in case that a preconfigured condition is satisfied, receive, from the CU-UP, a second message comprising information on data usage by means of the sidelink relay of the remote UE; and
transmit, to an access and mobility management function (AMF), a third message comprising information on the data usage by means of the sidelink relay of the remote UE.

10. The CU-CP of claim 9, wherein the controller is configured to:
in case that a connection state of the remote UE is changed from a connection through the sidelink relay to a radio interface connection with the base station, transmit, to the CU-UP, a fourth message comprising information indicating a state in which the connection through the sidelink relay is released;
receive, from the CU-UP, a fifth message comprising information on data usage by means of the sidelink relay of the remote UE until the connection through the sidelink relay is released; and
transmit, to the AMF, a sixth message comprising information on the data usage by means of the sidelink relay of the remote UE.

11. The CU-CP of claim 9, wherein the first message comprises at least one of a bearer context setup request message or a bearer context modification request message.

12. The CU-CP of claim 9, wherein the information on the data usage by means of the sidelink relay of the remote UE is a value calculated for each protocol data unit (PDU) session or each quality of service (QOS) flow, and
wherein the information on the data usage by means of the sidelink relay of the remote UE comprises at least one of information associated with a start time point of performing data transmission or reception using the sidelink relay, information associated with an end time point of performing data transmission or reception using the sidelink relay, uplink data usage information, or downlink data usage information.

13. A central unit-user plane (CU-UP) of a base station in a wireless communication system, the CU-UP comprising:
a transceiver; and
a controller connected to the transceiver and configured to:
receive, from a central unit-control plane (CU-CP) of the base station, a first message comprising information indicating whether a remote user equipment (UE) is in a state of being connected through a sidelink relay;
identify, based on the information, information on data usage by means of the sidelink relay of the remote UE; and
in case that a preconfigured condition is satisfied, transmit, to the CU-CP, a second message comprising information on the data usage by means of the sidelink relay of the remote UE.

14. The CU-UP of claim 13, wherein the controller is configured to:
in case that a connection state of the remote UE is changed from a connection through the sidelink relay to a radio interface connection with the base station, receive, from the CU-CP, a fourth message comprising information indicating a state in which the connection through the sidelink relay is released;
suspend calculation of the data usage by means of the sidelink relay of the remote UE; and
transmit, to the CU-CP, a fifth message comprising information on the data usage by means of the sidelink relay of the remote UE, the information being identified until a time point of the suspension of the calculation.

15. The CU-UP of claim 13, wherein the first message comprises at least one of a bearer context setup request message or a bearer context modification request message, wherein the information on the data usage by means of the sidelink relay of the remote UE is a value calculated for each protocol data unit (PDU) session or each quality of service (QoS) flow, and
wherein the information on the data usage by means of the sidelink relay of the remote UE comprises at least one of information associated with a start time point of performing data transmission or reception using the sidelink relay, information associated with an end time point of performing data transmission or reception using the sidelink relay, uplink data usage information, or downlink data usage information.
